(19) United States
(12) Patent Application Publication
(10) Pub. No.: US 2026/0370514 A1
(43) Pub. Date: Nov. 19, 2026

(54) OPTICAL LINK FOR SUPPORTING UNIVERSAL SERIAL BUS (USB) CONNECTION

(71) Applicant: OPTICIS CO., LTD., Seongnam-si (KR)

(72) Inventors: Dong Pyeong YANG, Seongnam-si (KR); Doo Soo HA, Seoul (KR)

(21) Appl. No.: 19/542,654

(22) Filed: Feb. 17, 2026

(30) Foreign Application Priority Data
May 16, 2025 (KR) 10-2025-0063983

(51) Int. Cl. H04L 12/40; H04L 5/14; H04L 25/49; H04L 41/0813; H04Q 11/00

(52) U.S. Cl. CPC H04L 12/40032; H04L 5/14; H04L 25/4904; H04L 41/0813; H04Q 11/0003; H04Q 2213/1334

(57) ABSTRACT

According to an optical link of the disclosure, as communication hosts that do not form a direct electrical connection with each other while an optical connection for optical communication is involved, a host and a device may form a direct electrical connection with each other and simulate a universal serial bus (USB) connection in which a pull-up resistor connected to a power terminal on the host side and a pull-down resistor connected to a ground terminal on the device side are directly connected through a configuration channel (CC), thereby implementing source current advertising for setting the voltage and current of a driving power between the communication hosts while detecting a voltage signal such as a voltage drop or voltage rise on the CC.

### CROSS-REFERENCE TO RELATED APPLICATION

This application is based on and claims priority under 35 U.S.C. §119 to Korean Patent Application No. 10-2025-0063983, filed on May 16, 2025, in the Korean Intellectual Property Office, the disclosure of which is incorporated by reference herein in its entirety.

### BACKGROUND

### 1. Field

The disclosure relates to an optical link for supporting a universal serial bus (USB) connection.

### 2. Description of the Related Art

An optical link provides an interface for optical communication between a source device generating a video signal and a sink device for implementing a video image from the video signal generated by the source device. The optical link may include a video signal line for transmitting video data and an auxiliary signal line for transmitting video auxiliary data, such as configuration information of the source or sink device, in addition to the video data.

### SUMMARY

According to an optical link according to an embodiment of the disclosure, as communication hosts that do not form a direct electrical connection with each other while an optical connection for optical communication is involved, a host and a device may form a direct electrical connection with each other and simulate a universal serial bus (USB) connection in which a pull-up resistor connected to a power terminal on the host side and a pull-down resistor connected to a ground terminal on the device side are directly connected through a configuration channel (CC), thereby implementing source current advertising for setting the voltage and current of a driving power between the communication hosts while detecting a voltage signal such as a voltage drop or voltage rise on the CC.

Additional aspects will be set forth in part in the description which follows and, in part, will be apparent from the description, or may be learned by practice of the presented embodiments of the disclosure.

In order to achieve the above and other objectives, an optical link for supporting a universal serial bus (USB) connection, according to an aspect of the disclosure, may include
an optical communication module on one side, which forms an electrical connection with a communication host on the one side through a configuration channel (CC), between communication hosts connected to both sides of the CC; and
an optical communication module on the other side, which forms an electrical connection with a communication host on the other side through the CC, between the communication hosts connected to both sides of the CC,
wherein configuration states of the optical communication modules on the one side and the other side may be set according to configuration states of the communication hosts on the other side and the one side, respectively, the communication hosts on the other side and the one side being connected to opposite sides to the communication hosts on the one side and the other side, respectively, as counterpart forming electrical connections with the optical communication modules on the one side and the other side, respectively.
That is, a configuration state of the optical communication module on the one side may be set according to a configuration state of the communication host on the other side, which is connected to an opposite side to the communication host on the one side as a counterpart forming an electrical connection with the optical communication module on the one side, and a configuration state of the optical communication module on the other side may be set according to a configuration state of the communication host on the one side, which is connected to an opposite side to the communication host on the other side as a counterpart forming an electrical connection with the optical communication module on the other side.

For example, the configuration state of the optical communication module on the one side may be set according to the configuration state of the communication host on the other side, which is connected to an opposite side to the communication host on the one side as a counterpart forming an electrical connection with the optical communication module on the one side, and
the configuration state of the optical communication module on the other side is set according to the configuration state of the communication host on the one side, which is connected to an opposite side to the communication host on the other side as a counterpart forming an electrical connection with the optical communication module on the other side.

For example, a configuration state of at least one of the optical communication modules on the one side and the other side may be switched according to a configuration state of a communication host connected to an opposite side to the communication host as a counterpart forming the electrical connection with the at least one of the optical communication modules.

For example, in order for a first optical communication module on the one side to simulate a configuration state of a second communication host connected to an opposite side to a first communication host on the one side, which forms an electrical connection with the first optical communication module on the one side, and in order for a second optical communication module on the other side to simulate a configuration state of the first communication host connected to an opposite side to the second communication host on the other side, which forms an electrical connection with the second optical communication module on the other side,
a configuration state of the second optical communication module may be switched according to the configuration state of the first communication host recognized through communication with the first optical communication module.

For example, the first optical communication module may detect the configuration state of the first communication host, which forms an electrical connection with the first optical communication module, and may transmit information about the detected configuration status of the first communication host to the second optical communication module, thereby switching the configuration state of the second optical communication module.

For example, the configuration states of the communication hosts on the one side and the other side may include a configuration state regarding a role of a host or a role of a device set for each communication host.

For example, the configuration states of the communication hosts on the one side and the other side may include a connection state of a pull-up resistor or a pull-down resistor in each communication host.

For example, in order for a first optical communication module on the one side to simulate a connection state of a pull-up resistor or a pull-down resistor in a second communication host connected to an opposite side to a first communication host on the one side, which forms an electrical connection with the first optical communication module on the one side, and in order for a second optical communication module on the other side to simulate a connection state of a pull-up resistor or a pull-down resistor in the first communication host connected to an opposite side to the second communication host on the other side, which forms an electrical connection with the second optical communication module on the other side,
the connection state of the pull-up resistor or the pull-down resistor in at least one of the first optical communication module or the second optical communication module may be switched based on information about the connection state of the pull-up resistor or the pull-down resistor in the second communication host or the first communication host, the information being recognized by communication with the second optical communication module or the first optical communication module connected to an opposite side to the first optical communication module or the second optical communication module.

An optical link for supporting an USB connection, according to another aspect of the disclosure, may include
a first optical communication module, which forms a first electrical connection with a host as a communication host on one side through a configuration channel (CC), between the host and a device that form communication hosts on both sides of the CC; and
a second optical communication module, which forms a second electrical connection with a device as a communication host on the other side through the CC, between the host and the device that form the communication hosts on both sides of the CC,
wherein configuration states of the first and second optical communication modules may be set according to configuration states of a device and host connected to opposite sides to the host and device as counterparts forming the first and second electrical connections, respectively.

For example, the configuration states of the first and second optical communication modules may be set according to configuration states of a communication host connected to an opposite side to the communication host as the counterpart, which form the first and second electrical connections, respectively.

For example, the configuration state of the first optical communication module may be set according to a configuration state of a device to simulate a configuration state of a device connected to an opposite side to a host as a counterpart forming the first electrical connection, and
the configuration state of the second optical communication module may be set according to a configuration state of a host to simulate a configuration state of a host connected to an opposite side to a device as a counterpart forming the second electrical connection.

For example, a configuration state of at least one of the first and second optical communication modules may be switched according to a configuration state of a communication host connected to an opposite side to a communication host as a counterpart forming at least one of the first and second electrical connections.

For example, the configuration state of the second optical communication module
may be switched according to a configuration state of a host connected to an opposite side to a device as a counterpart forming the second electrical connection with the second optical communication module.

For example, the configuration state of the second optical communication module
may be switched according to a configuration state of a host recognized through communication with the first optical communication module forming a first electrical connection with a host connected to an opposite side to a device as a counterpart forming a second electrical connection with the second optical communication module.

For example, the first optical communication module may detect the configuration state of the host through the CC forming the first electrical connection, and may transmit information about the detected configuration state of the host to the second optical communication module, thereby switching the configuration status of the second optical communication module.

An optical link for supporting an USB connection, according to another aspect of the disclosure, may include
a first optical communication module that provides a pull-down resistor connected to a pull-up resistor of the host to implement a role of a complementary device to the host through the CC forming a first electrical connection with the host between the host and the device that form communication hosts on both sides of the CC, and generates an output voltage on the CC;
a second optical communication module that provides a pull-up resistor connected to a pull-down resistor of the device to implement a role of a complementary host to the device through the CC forming a second electrical connection with the device, and generates an output voltage on the CC; and
an optical cable that provides optical communication between the first optical communication module and the second optical communication module.

For example, each of the first optical communication module and the second optical communication module may include
a plurality of switch elements that selectively control a connection between each of the pull-up resistor and the pull-down resistor having different resistance levels and the CC; and
a first operation processing logic that outputs a switching control signal for controlling turn-on/turn-off of the plurality of switch elements,
wherein the first operation processing logic of the first optical communication module may output a switching control signal for connecting a pull-down resistor connected to a pull-up resistor of the host to the CC, and
the first operation processing logic of the second optical communication module may output a switching control signal for connecting a pull-up resistor connected to a pull-down resistor of the device to the CC.

For example, each of the first optical communication module and the second optical communication module may include
a plurality of pull-up resistors having different resistance levels and a pull-down resistor having a fixed resistance level.

For example, a first operation processing logic of the first optical communication module may output a switching control signal for connecting a pull-down resistor having a fixed resistance level to the CC, and
a first operation processing logic of the second optical communication module may connect a first pull-up resistor having an arbitrary resistance level among pull-up resistors having a plurality of resistance levels to the CC at an initial stage of connection between the second optical communication module and the device, and then outputs a switching control signal for implementing a switching of the pull-up resistor to switch an activated pull-up resistor, to disconnect the first pull-up resistor from the CC according to a level confirmation signal transmitted from the first optical communication module, and to connect, to the CC, a second pull-up resistor having a resistance level corresponding to a resistance level of a pull-up resistor of the host recognized from the level confirmation signal.

For example, the first operation processing logic of the second optical communication module
may connect, at the initial stage of connection between the second optical communication module and the device, a pull-up resistor having a highest resistance level among pull-up resistors having different resistance levels, as the pull-up resistor having the arbitrary resistance level, to the CC.

For example, a level of power supply current between the host and the device as communication hosts may be set according to a level of an output voltage on the CC that forms the second electrical connection between the pull-up resistor of the second optical communication module and the pull-down resistor of the device,
wherein the level of the power supply current may be set according to a level of an output voltage on the CC that is inversely correlated with a resistance level of the pull-up resistor of the second optical communication module, depending on a voltage drop from the pull-up resistor of the second optical communication module.

For example, the first optical communication module may generate a level confirmation signal and transmit the level confirmation signal to the second optical communication module, according to a level of an output voltage generated on the CC that forms the first electrical connection according to voltage distribution between the pull-down resistor of the first optical communication module and the pull-up resistor of the host, or according to a resistance level of a pull-up resistor recognized according to the output voltage, and
the second optical communication module may connect a pull-up resistor corresponding to the pull-up resistor of the host recognized according to the level confirmation signal to the CC, so that
the level of the output voltage on the CC that forms the first electrical connection between the host and the first optical communication module and the level of the output voltage on the CC that forms the second electrical connection between the device and the second optical communication module may correspond to each other.

For example, the power supply current between the host and the device may be set depending on the output voltage on the CC that forms the first electrical connection between the pull-up resistor of the host and the pull-down resistor of the first optical communication module, or
the output voltage on the CC that forms the second electrical connection between the pull-down resistor of the device and the pull-up resistor of the second optical communication module.

For example, each of the host and device forming the communication hosts may support a Dual Role Port (DRP), which is set to a role of the host or Down Facing Port (DFP) and a role of the device or Up Facing Port (UFP) according to matching of high and low levels that alternate with each other according to a duty cycle set as a DRP signal output on the CC, and
a first operation processing logic of each of the first and second optical communication modules
may detect a first electrical connection with the host or a second electrical connection with the device from a change in an output voltage on the CC due to a high-level voltage drop of the DRP signal or a low-level voltage rise of the DRP signal, according to a voltage distribution between the pull-up resistor of the host or the second optical communication module implementing the role of the host and the pull-down resistor of the device or the first optical communication module implementing the role of the device,
wherein power supply may be set between the host and the device based on the level of the output voltage on the CC according to the high-level voltage drop of the DRP signal or the low-level voltage drop of the DRP signal due to connection between the pull-up resistor and the pull-down resistor.

For example, each of the first and second optical communication modules may include
a first operation processing logic that processes a DRP signal having alternating high and low levels according to a duty cycle set on the CC, or an analog voltage signal having an output voltage that has captured a voltage drop or voltage rise of the DRP signal; and
a second operation processing logic that processes a bit stream for data transmission on the CC or encoded data obtained by applying Biphase Mark Coding (BMC) to transmission data.

For example, to detect the level of the output voltage of the CC based on a voltage drop or voltage rise of the DRP signal due to connection between the pull-up resistor of the host or the second optical communication module implementing the role of the host and the pull-down resistor of the device or the first optical communication module implementing the role of the device on the CC, the first operation processing logic may detect the level of the output voltage of the CC according to an output from an analog to digital converter (ADC) for categorizing or quantizing the output voltage of the CC and set the power supply between the host and the device.

For example, the first operation processing logic or a processor element in which the first operation processing logic is configured may include an input terminal for the DRP signal to which a signal having an output voltage on the CC that has captured the DRP signal or the voltage drop or rise of the DRP signal is input, an input terminal of an ADC to which an output of an ADC for categorizing or quantizing the output voltage that has captured the voltage drop or rise of the DRP signal is input, and an output terminal for outputting a switching control signal for controlling the connection between a pull-up resistor and pull-down resistor having different resistance levels and the CC.

For example, the first operation processing logic or the processor element in which the first operation processing logic is configured
may further include an input/output terminal for outputting transmission data from a first optical communication module or a second optical communication module including the first operation processing logic or the processor element to a second optical communication module or a first optical communication module connected to another end of the optical link and for inputting reception data from the second optical communication module or the first optical communication module connected to the other end of the optical link.

For example, the second operation processing logic or a processor element in which the second operation processing logic is configured may include an input terminal and an output terminal for inputting and outputting, respectively, the bit stream for data transmission or the encoded data obtained by applying BMC to the transmission data.

For example, a BMC signal processor may be connected to a BMC data reception line between the input terminal of the second operation processing logic, into which the bit stream for data transmission or the encoded data obtained by applying BMC to the transmission data is input, and the host or the device that functions as the communication host.

For example, the BMC signal processor
may amplify a peak of a signal input from the host or device functioning as the communication host toward the second operation processing logic through the BMC data reception line, and shape the input signal into a signal in which a time delay of a rising edge and falling edge thereof that form signal dispersion is shortened.

For example, the BMC signal processor
may receive an about 1.2 volts or about 1.1 volts peak-to-peak swing signal as an input and may output an about 3.3 volts peak-to-peak swing signal.

For example, the BMC signal processor
may include a comparator including a non-inverting terminal to which a bit stream of a BMC signal input via the BMC data reception line is input, and an inverting terminal to which a reference voltage is input.

For example, duplexing may be implemented on a BMC data reception line and a BMC data transmission line, respectively connected to an input terminal and output terminal of the second operation processing logic, to support bidirectional communication via the CC of a single channel.

For example, a duplexing switch element for opening and closing a transmission line may be connected to a BMC data transmission line between the output terminal of the second operation processing logic, from which the bit stream for data transmission or the encoded data obtained by applying BMC to the transmission data is output, and the host or the device that functions as the communication host.

For example, each of the host and device forming the communication hosts may support a DRP, in which a role of the host or DFP and a role of the device or UFP are set according to matching of high and low levels that alternate with each other according to a duty cycle set as a DRP signal output on the CC,
the host and device may attempt a Power Role (PR) swap to reset a previously set role to a role complementary thereto through Power Delivery (PD) communication on the CC, and
as the PR swap is implemented according to the PR swap attempt,
1) the second optical communication module, which has implemented the role of a complementary host to the device prior to the PR swap, may generate a switching control signal to disconnect the pull-up resistor from the CC to disable the pull-up resistor and connect a pull-down resistor having a fixed resistance level to the CC to enable the pull-down resistor having the fixed resistance level, in order to implement the role of a complementary device to a PR-swapped host, and
may transmit a level confirmation signal regarding the pull-up resistor of the PR-swapped host, which is calculated from or based on an output voltage formed on the CC according to connection between the pull-up resistor of the PR-swapped host and the pull-down resistor of the second optical communication module, toward the first optical communication module connected to another end of the optical link, and
2) the first optical communication module, which has implemented the role of a complementary device to the host prior to the PR swap, may generate a switching control signal to disconnect the pull-down resistor from the CC to disable the pull-down resistor and connect a pull-up resistor corresponding to the pull-up resistor of the PR-swapped host to the CC according to the level confirmation signal received from the second optical communication module to enable the pull-up resistor, in order to implement the role of a complementary host to the PR-swapped device.

For example, the first and second optical communication modules may switch a resistor that is enabled and disabled between a pull-up resistor and a pull-down resistor according to the reception of a PR swap message in a BMC signal transmitted via PD communication on the CC between the host and the device that form the communication hosts.

For example, the first and second optical communication modules may switch a resistor that is enabled and disabled between a pull-up resistor and a pull-down resistor, according to a voltage drop in power supply of a VBUS connected to the communication host.

For example, each of the first and second optical communication modules may include
a multiplexer that implements multiplexing of a DRP signal and a BMC signal output from different first and second operation processing logics in order to multiplex an output of the first operation processing logic for processing the DRP signal on the CC and an output of the second operation processing logic for processing the BMC signal on the CC and transmit multiplexed outputs through the CC of a single channel, and an optical transmitter connected between the multiplexer and an optical cable.

For example, the multiplexer may multiplex a level confirmation signal output from the first operation processing logic and a BMC signal output from the second operation processing logic, and may output an electrical signal obtained by multiplexing the level confirmation signal and the BMC signal, and
the optical transmitter may perform photoelectric conversion from the electrical signal obtained by multiplexing the level confirmation signal and the BMC signal to an optical signal obtained by multiplexing the level confirmation signal and the BMC signal.

For example, each of the first and second optical communication modules may include
a demultiplexer that demultiplexes a signal received from an optical cable providing the CC of a single channel into a DRP signal and a BMC signal respectively input to different first and second operation processing logics, and an optical receiver connected between the demultiplexer and an optical cable, so as to demultiplex a signal transmitted from the CC of the single channel into an input of the first operation processing logic for processing the DRP signal on the CC and an input of the second operation processing logic for processing the BMC signal on the CC and transmit the demultiplexed signal to each of the first and second operation processing logics.

For example, each of the first and second optical communication modules may include
an optical receiver that converts an optical signal including a level confirmation signal and a BMC signal multiplexed with each other, transmitted from the second and first optical communication modules connected to another end of the optical cable, into an electrical signal including a level confirmation signal and a BMC signal multiplexed with each other, and a demultiplexer that demultiplexes an electrical signal including a level confirmation signal and a BMC signal multiplexed with each other, output from the optical receiver, toward each of the first and second operation processing logics.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a drawing for explaining a first optical communication module that implements the role of a complementary device to a host through a configuration channel (CC) that forms a first electrical connection with the host as a universal serial bus (USB) communication host in an embodiment of the disclosure and illustrates a first optical communication module for implementing source current advertising for setting a power supply between a host and a device as communication hosts according to a level of an output voltage on a CC that forms a first electrical connection through a pull-up resistor of the host and a pull-down resistor of the first optical communication module that implements the role of the device and for implementing PD communication through the CC after the source current advertising;

FIG. 2 is a diagram for explaining a second optical communication module that implements the role of a complementary host to a device through a CC that forms a second electrical connection with the device as a USB communication host in an embodiment of the disclosure and illustrates a second optical communication module for implementing source current advertising for setting a power supply between a host and a device as communication hosts according to a level of an output voltage on a CC that forms a second electrical connection through a pull-down resistor of the device and a pull-up resistor of the second optical communication module that implements the role of the host and for implementing PD communication through the CC after the source current advertising;

FIG. 3 is a diagram for explaining a USB pin assignment including CCs that implement source current advertising and PD communication between a host and a device as communication hosts in a USB connection supported by an optical link according to an embodiment of the disclosure and high-speed channels for high-speed data transmission;

FIGS. 4A-5B are diagrams for explaining source current advertising implemented between a host and a device as communication hosts through a CC in a USB connection supported by an optical link according to an embodiment of the disclosure, wherein different levels of current of a power supply are set between the host and the device according to the level of an output voltage on the CC formed according to the voltage distribution between a pull-up resistor of the host and a pull-down resistor of the device, connected to the CC, in which FIGS. 4A-5B illustrate a phase of source current advertising in which a current (about 1.5 A) of a power supply is set in a range (~ about 0.95 V) of an output voltage on the CC or a current (about 3.0 A) of a power supply is set in a range (~ about 1.7 V) of an output voltage on the CC, and a phase of power supply in which a set power supply is performed between the host and the device as communication hosts through a bus after the source current advertising;

FIGS. 6 and 7 are diagrams for explaining a USB connection between communication hosts through a CC, and illustrates that a connection between a host and a device as the communication hosts is detected (see FIG. 6), the roles of the host or Down Facing Port (DFP) and the device or Up Facing Port (UFP) are set through a pull-up resistor of the host and a pull-down resistor of the device (see FIG. 6), a CC for PD communication is set (see FIG. 7), and through Vconn (see FIG. 7), a pull-down resistor is detected and power is supplied to an Active Cable Circuitry (Electronically Marked IC (EMIC));

FIG. 8 is a diagram for explaining a Biphase Mark Coding (BMC) signal or BMC coding for PD communication between a host and a device as communication hosts, and illustrates a signal waveform of input data and a signal waveform of encoded data obtained by applying BMC to the input data;

FIG. 9 is a diagram for explaining that an output voltage is formed on a CC according to the voltage distribution between a pull-up resistor and a pull-down resistor through a first electrical connection between a host as a communication host and a first optical communication module that implements the role of a complementary device to the host, or a second electrical connection between a device as a communication host and a second optical communication module that implements the role of a complementary host to the device, according to an embodiment of the disclosure, and schematically illustrates the connection of a pull-up resistor and a pull-down resistor through the CC;

FIGS. 10-12 are diagrams for explaining the level or range of current of a power supply set for the level or range of an output voltage formed on a CC according to the voltage distribution between a pull-up resistor and a pull-down resistor through a first electrical connection between a host as a communication host and a first optical communication module that implements the role of a complementary device to the host, or a second electrical connection between a device as a communication host and a second optical communication module that implements the role of a complementary host to the device, and schematically illustrate the connection of a pull-up resistor and a pull-down resistor of the first electrical connection or the second electrical connection implemented through the CC;

FIG. 13 is a diagram illustrating a waveform of a Dual Role Port (DRP) signal of a toggle signal in which a high level (source) signal and a low level (sink) signal alternate according to a duty cycle and illustrates the waveform of the DRP signal which cycles as a source/sink within about 50 msec to about 100 msec, during which time the DRP signal may be a source for about 30% to about 70% of the time, and in which the transition from source to sink and from sink to source does not exceed about 1 msec, and also illustrates that the role of a host or a device is implemented according to matching based on the duty cycle of the DRP signal between the host as a communication host and a first optical communication module that implements the role of a complementary device to the host and between the device as a communication host and a second optical communication module that implements the role of a complementary host to the device;

FIG. 14 is a diagram for explaining a Power Role (PR) swap attempt from PD communication implemented through a CC between a host and a device as communication hosts, between a host as a communication host and a first optical communication module implementing the role of a complementary device to the host, or between a device as a communication host and a second optical communication module implementing the role of a complementary host to the device and illustrates a DRP State Machine for switching from source to sink and from sink to source;

FIG. 15 is a drawing for explaining a configuration of a BMC signal processor, that is, for explaining a BMC signal processor for amplifying a peak of a signal input from a host or device functioning as a communication host toward a first operation processing logic through a BMC data reception line and for shaping the input signal into a signal in which a time delay of a rising edge and falling edge thereof that form signal dispersion is shortened, and illustrates a BMC signal processor including a non-inverting terminal (+), to which a bit stream for data transmission of a BMC signal input through a BMC data reception line is input, and an inverting terminal (-), to which a reference voltage is applied, and for outputting a maximum voltage signal (high level) according to a driving power and a signal having a square wave shape including steep rising and falling edges and having a shortened time delay;

FIGS. 16A and 16B are diagrams illustrating a waveform of an input signal (FIG. 16A) of a bit stream forming BMC data input to the BMC signal processor shown in FIG. 15 and a waveform of an output signal (FIG. 16B) from the BMC signal processor, respectively, and illustrate a waveform of an output signal shaped in a form in which the level of the maximum voltage forming a high level rises and the time delay between a rising edge and a falling edge is shortened; and

FIG. 17 is a diagram illustrating a waveform of a DRP signal captured over time on a CC connecting a host or device as a communication host to a first or second optical communication module implementing the role of a complementary device to the host or the role of a complementary host to the device, and illustrates a waveform of a DRP signal on the CC, in which an output voltage lowered from a high level in the host or the second optical communication module implementing the role of the host, or an output voltage (peak signal V2) raised from a low level in the device or the first optical communication module implementing the role of the device is captured as an output voltage divided between a pull-up resistor and a pull-down resistor according to the connection of the pull-up resistor and the pull-down resistor from a toggle signal (peak voltage V3) alternating between a source and a sink according to a duty cycle and then a Vpeak-Vpeak swing signal (peak voltage V3) of about 1.2 V (or about 1.1 V) is captured as a BMC signal transmitted through the CC.

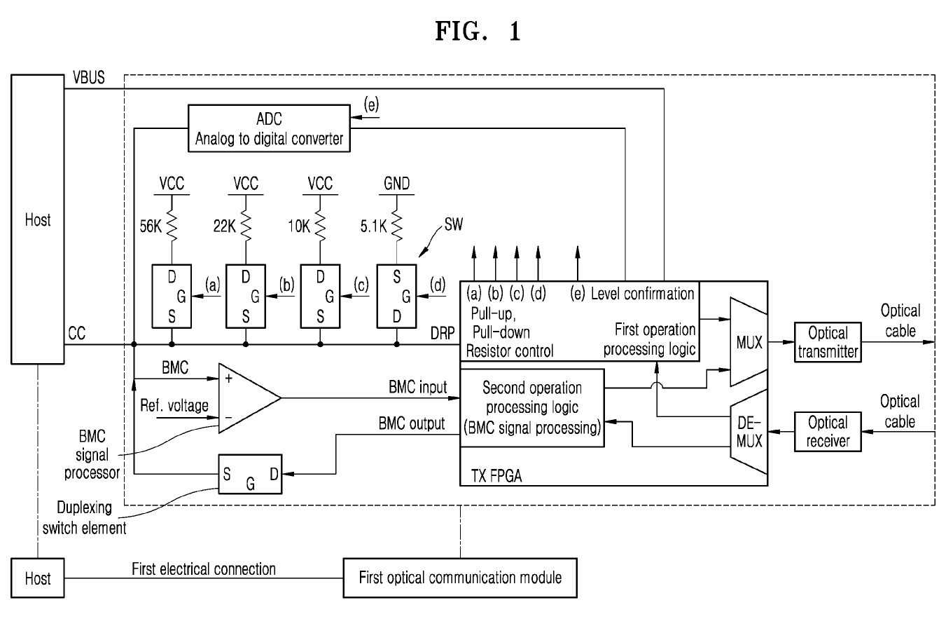

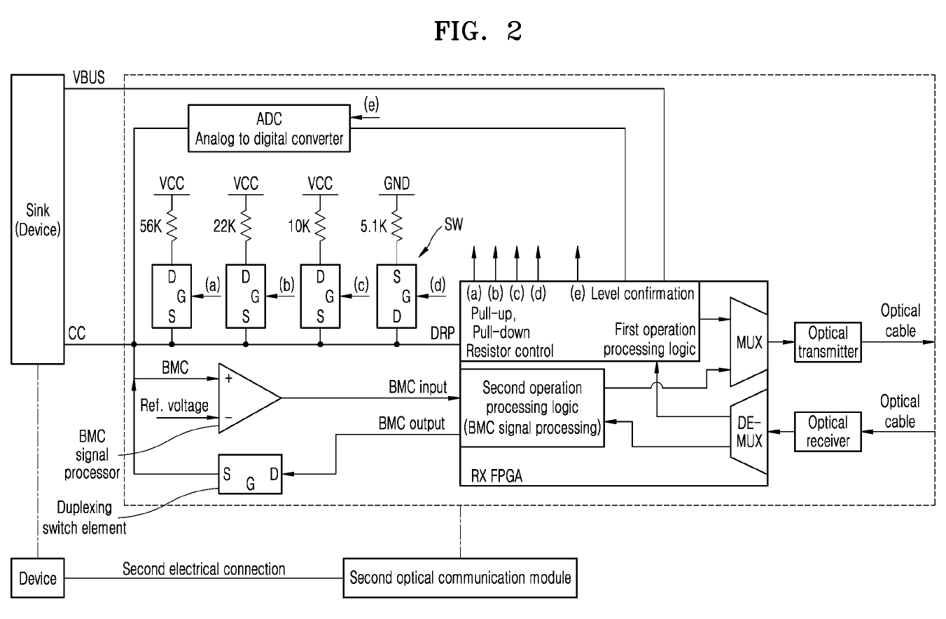

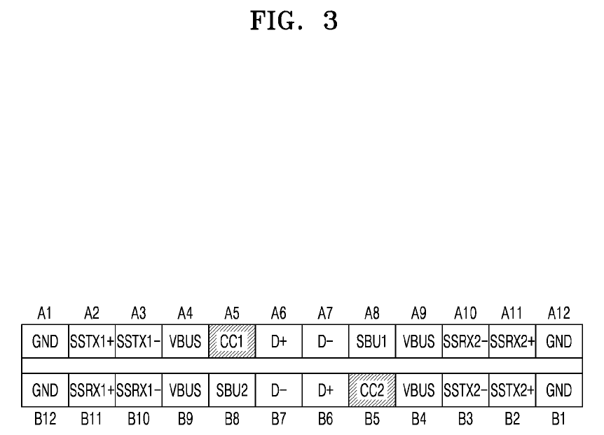

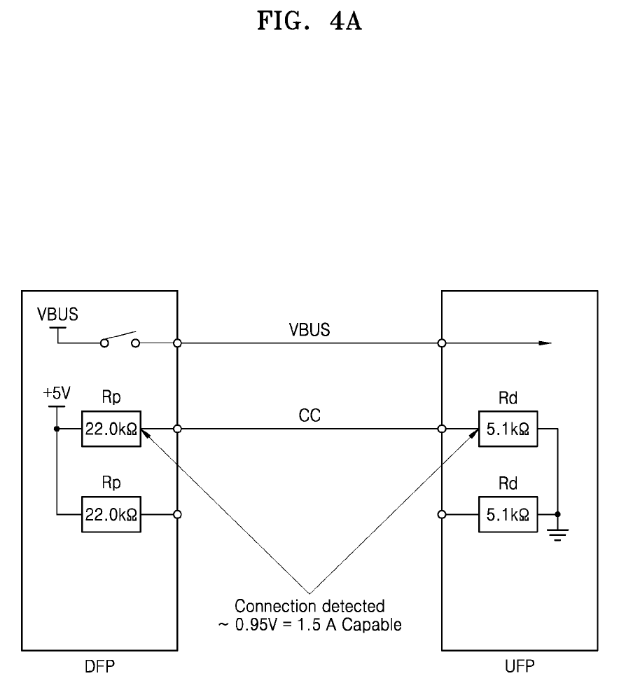

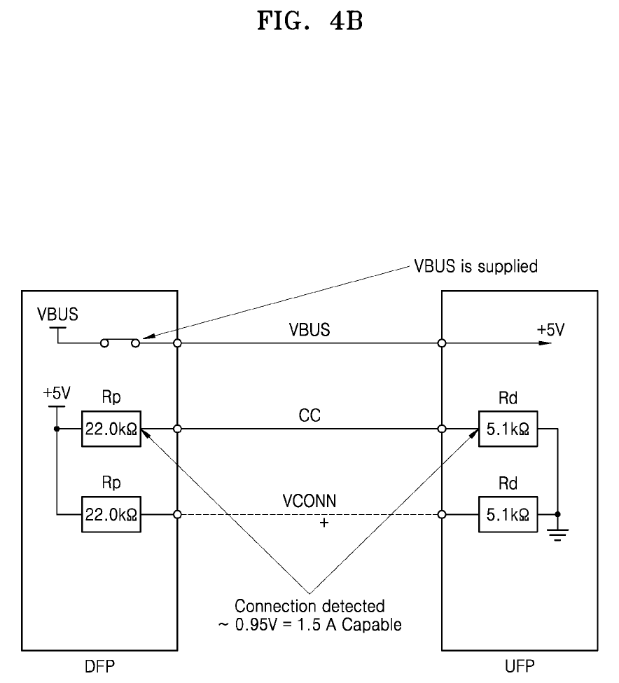

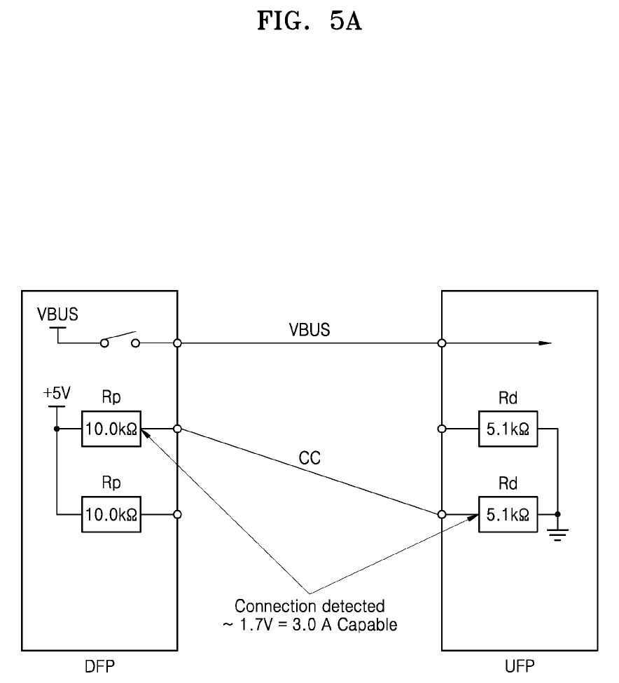

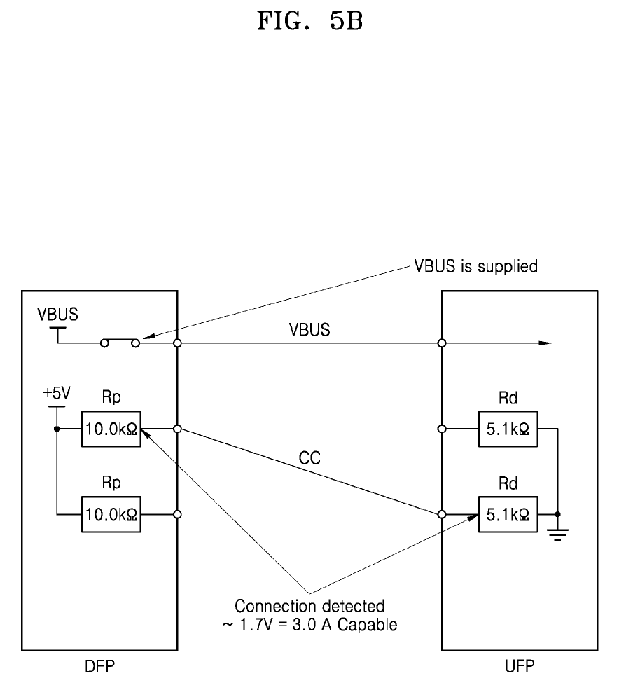

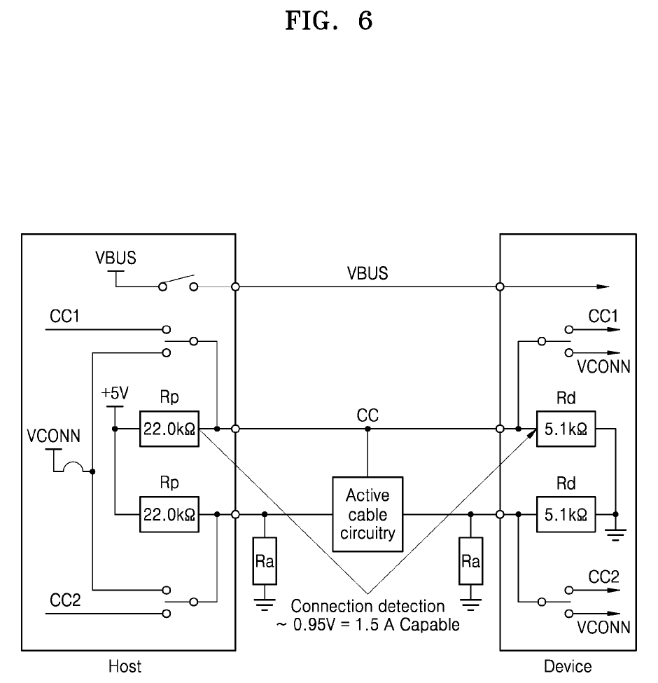

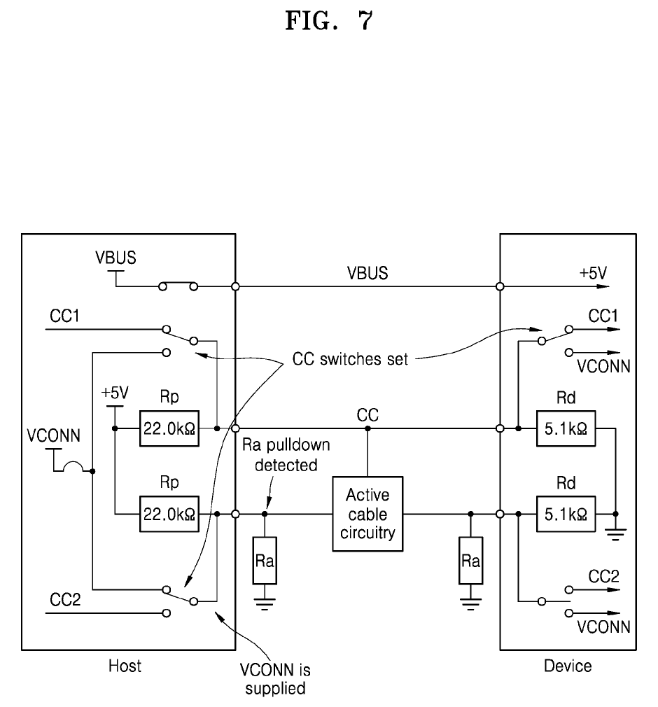

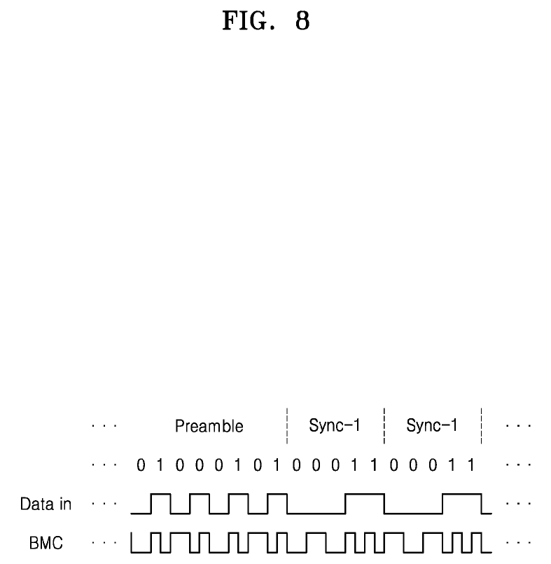

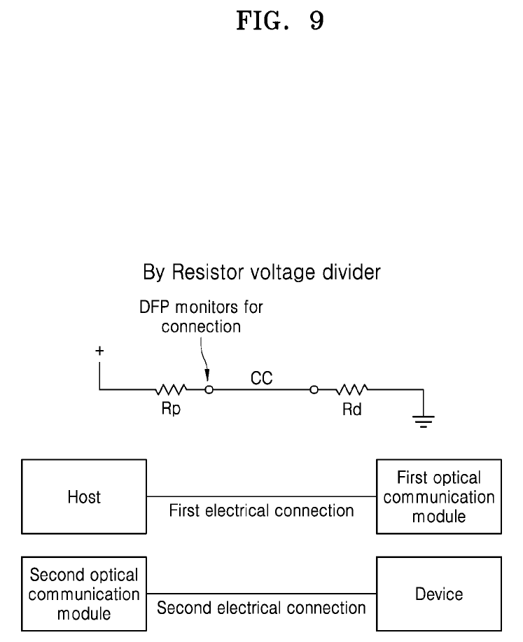

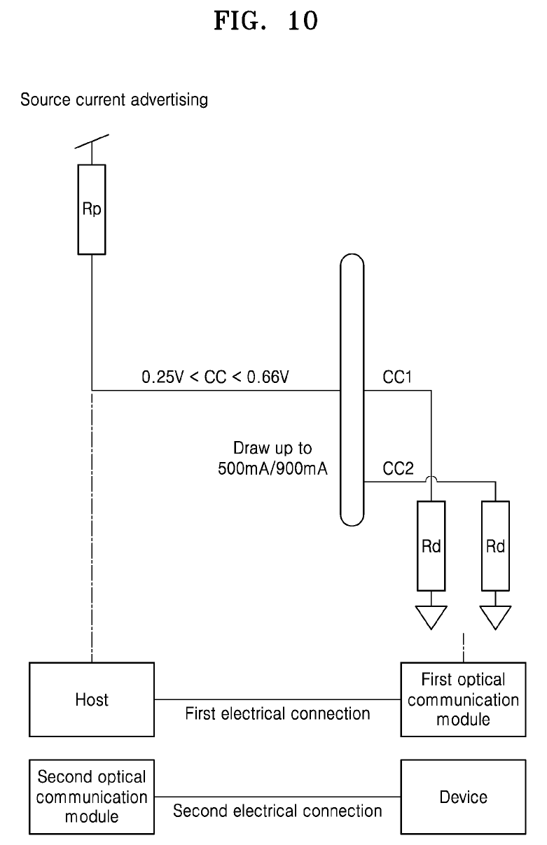

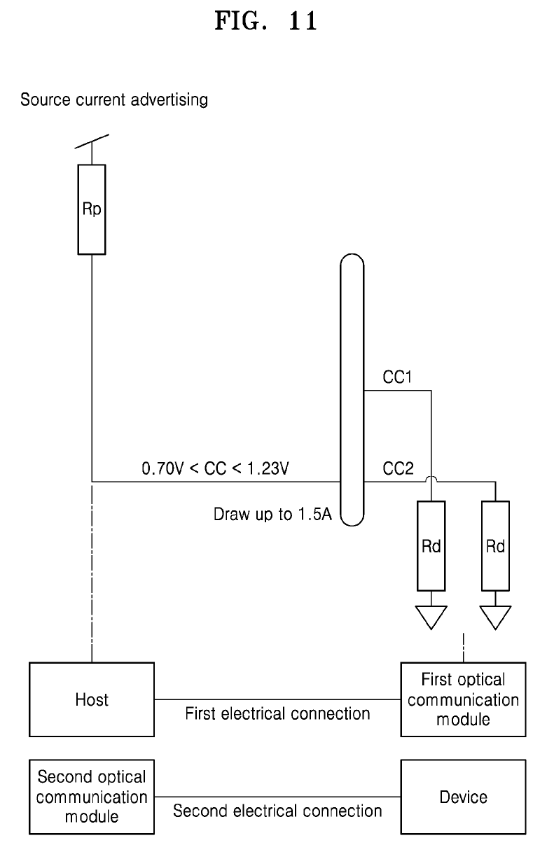

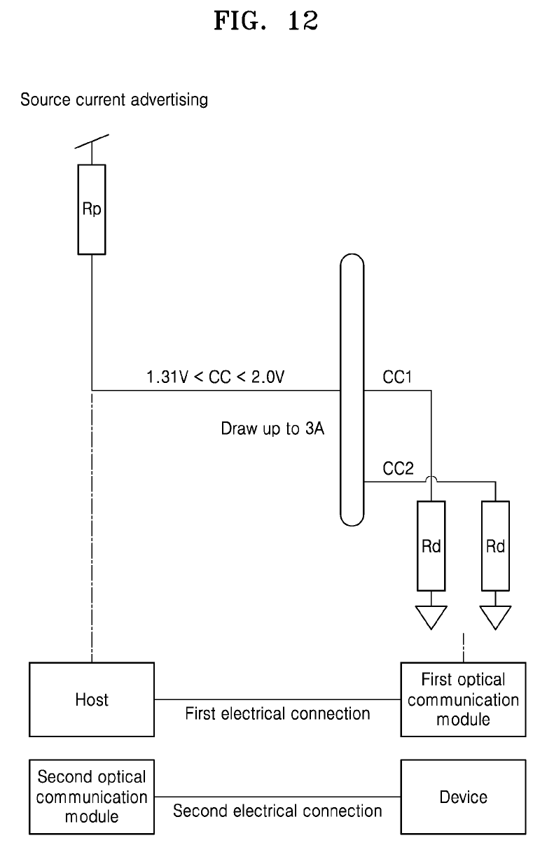

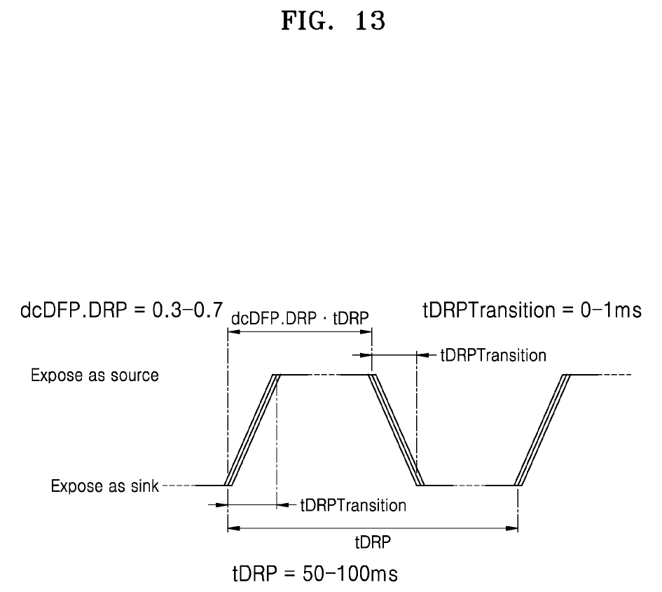

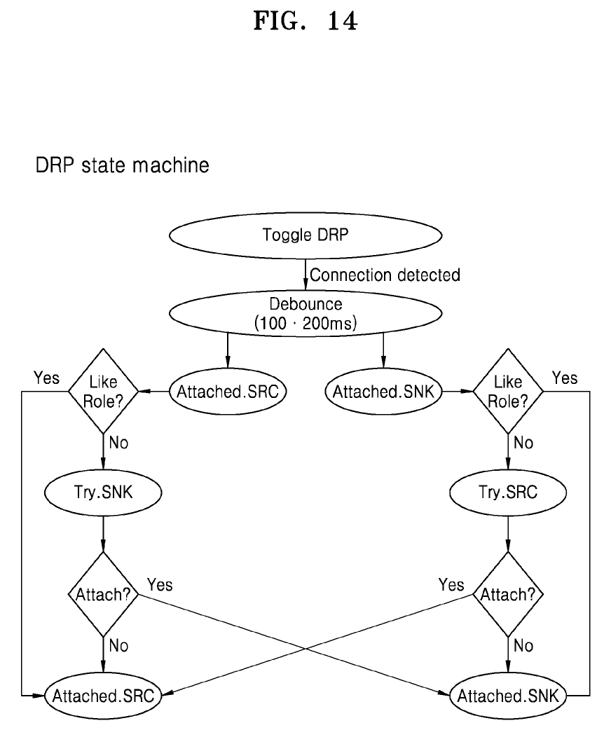

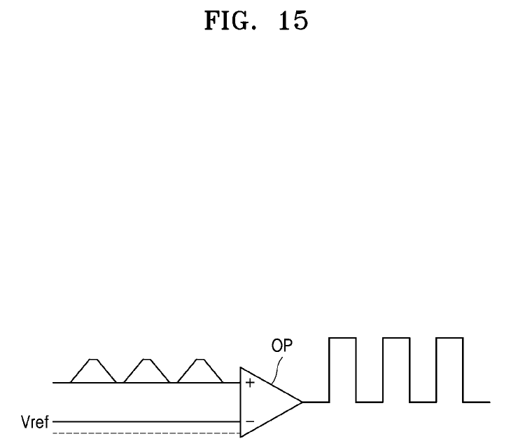

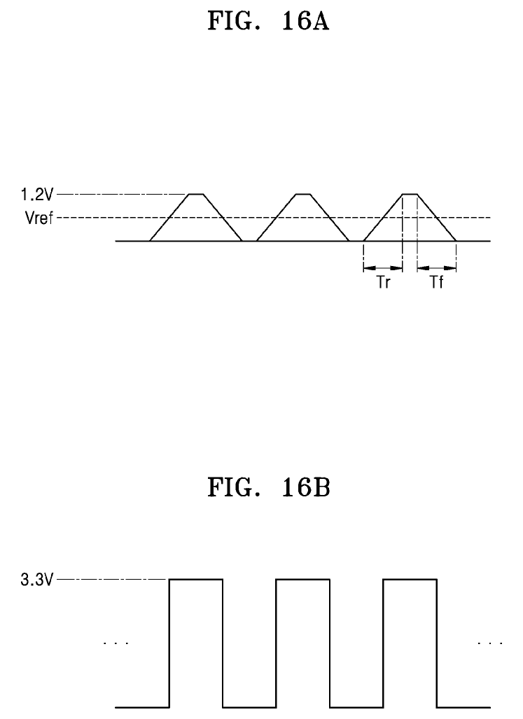

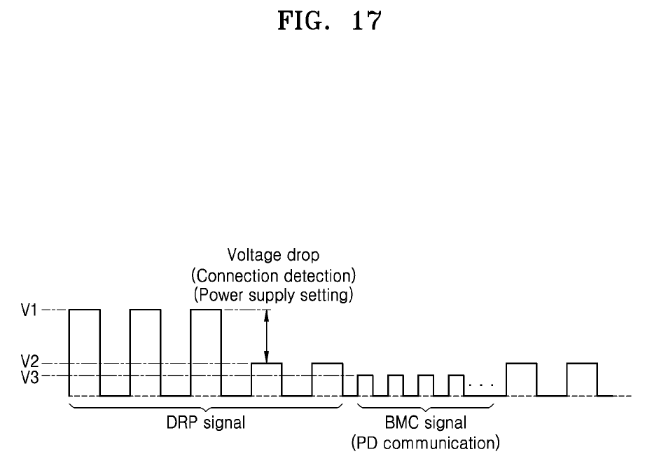

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term "and/or" includes any and all combinations of one or more of the associated listed items. Expressions such as "at least one of," when preceding a list of elements, modify the entire list of elements and do not modify the individual elements of the list.

Hereinafter, with reference to the drawings attached to this specification, an optical link supporting a universal serial bus (USB) connection according to an embodiment of the disclosure will be described.

Before describing the optical link according to an embodiment of the disclosure, a USB connection supported by the optical link according to the disclosure will first be described, and then the optical link according to an embodiment of the disclosure will be described.

In a USB connection supported by an optical link according to an embodiment of the disclosure, the voltage and current of power supply between a host (or Down Facing Port (DFP)) and a device (or Up Facing Port (UFP)) as communication hosts of the USB connection may be set through source current advertising. More specifically, the voltage and current of the power supply supplied from the host to the device may be set. In an embodiment of the disclosure, in the source current advertising, the voltage and current of the power supply from the host (or DFP) as a power source to the device (or UFP) as a power sink may be set. For example, in an embodiment of the disclosure, in the source current advertising, a voltage of about 5 V may be set as the voltage of the power supply from the host side forming a communication host to the device side, and a current (about 1.5 A or about 3.0 A) of the power supply may be set from the power of about 1.5 A@5 V or about 3.0 A@5 V as the current of the power supply from the host side forming the communication host to the device side. More specifically, from the source current advertising, the voltage of power supply from the host at the other end of the USB connection may be set to about 5V through a pull-down resistor Rd (about 5.1kΩ) connected to the ground terminal on the device (e.g., UFP) side as a communication host, and the host (e.g., DFP) side as a communication host may determine whether to supply about 1.5A current or about 3.0A current toward the device at the other end of the USB connection, through a pull-up resistor Rp (about 22kΩ or about 10kΩ) connected to the power terminal (e.g., about 5V or about 4.75V to about 5.5V).

In an embodiment of the disclosure, the source current advertising for setting up power supply between a host (or DFP) and a device (or UFP) as communication hosts may be implemented through a configuration channel (CC) between USB-connected communication hosts, and through the CC, together with source current advertising, whether a counterpart communication host (i.e., a communication host on the other side) is USB-connected and the USB connection orientation regarding Flipped/Un-flipped may be detected. In an embodiment of the disclosure, in the source current advertising, the current of the power supply from the host side to the device side may be set by detecting a pull-up resistor Rp connected to a power terminal on the host side corresponding to the source side of the power supply, and for example, depending on the pull-up resistor Rp, for example, depending on the pull-up resistor Rp detected according to a voltage drop in a DRP signal through a CC, the current of the power supply may be set to Default USB Power (e.g., about 500 mA or about 900 mA) for a pull-up resistor Rp of about 56 kΩ, about 1.5 A for a pull-up resistor Rp of about 22 kΩ, and about 3.0 A for a pull-up resistor Rp of about 10 kΩ. In an embodiment of the disclosure, the current of the power supply from the host as a communication host to the device may be set according to the pull-up resistor Rp (e.g., about 56 kΩ, about 22 kΩ, or about 10 kΩ) connected to the power terminal on the host side. The pull-down resistor Rd on the device side connected to the pull-up resistor Rp on the host side through the CC may be set to about 5.1 kΩ, and for example, the pull-down resistor Rd connected to the ground terminal on the device as a communication host may be set to a constant value. In this way, the pull-down resistor Rd connected to the ground terminal on the device side may set the voltage (e.g., about 5 V) of the power supply.

In an embodiment of the disclosure, the CC may transmit a Dual Role Port (DRP) signal, and the host and device forming the communication hosts in the USB connection supported by the optical link of the disclosure may support the DRP, and the role of the DFP or UFP may be set for the host or device forming the communication host, according to the duty cycle of the DRP signal.

For example, the DRP signal may cycle between source and sink within about 50 msec to about 100 msec (tDRP, toggle signal) and may be the source for about 30% to about 70% of this time (dcSRC.DRP), and the transition from the source to the sink and from the sink to the source may not exceed about 1 msec (tDRPTransition). For example, in the DRP signal on the host side that prefers DFP, the duty cycle (e.g., max. 70%) may be set so that the high level on period extends relatively longer than the low level off period. In the DRP signal on the device side that prefers UFP, the duty cycle (e.g., min. 30%) may be set so that the low level off period extends relatively longer than the high level on period.

In an embodiment of the disclosure, the DRP signal may include a toggle signal that alternates between a high level (e.g., about 5 V) and a low level (e.g., about 0 V) according to the duty cycle. When the host and the device forming the communication hosts are connected to each other via USB, a voltage drop in a high-level (e.g., about 5 V) signal detected through the CC may be detected, and when the voltage drop is detected, the connection of a counterpart communication host of the USB connection may be detected. In this way, each of the host and the device, which form the communication hosts, may detect the USB connection of a counterpart communication host by detecting the voltage drop through the CC. In this case, the voltage drop of the CC or the dropped voltage on the CC may be determined from the voltage distribution between the pull-up resistor Rp connected to the power terminal on the host as a USB-connected communication host and the pull-down resistor Rd connected to the ground terminal on the device side. Depending on the voltage on the CC according to the voltage distribution, for example, when the voltage (VCC) of the CC satisfies the condition of 1.31V < VCC < 2.04V, a current of the power supply of about 3.0A may be set, and when the voltage (VCC) of the CC satisfies the condition of 0.70V < VCC < 1.23V, the current of the power supply of about 1.5A may be set. Furthermore, when the voltage (VCC) of the CC satisfies the condition of 0.25V < VCC < 0.66V, the current of the power supply of Default USB Power (e.g., about 500mA or about 900mA) may be set.

In this way, in an embodiment of the disclosure, power may be supplied from a host (or DFP) as a source to a device (or UFP) as a sink via VBUS according to the current and voltage of the power supply set according to source current advertising for setting the current and voltage of the power supply between the host and the device forming the USB communication hosts.

For example, a USB connection may be detected by detecting the voltage drop of the DRP signal on the CC through a pull-up resistor Rp connected to the power terminal on the host forming the communication host and a pull-down resistor Rd connected to the ground terminal on the device side. The pull-up resistor Rp or pull-down resistor Rd of the counterpart communication host that is USB-connected may be detected, and the current of the power supply between the host and the device may be set according to the detected pull-up resistor Rp. In an embodiment of the disclosure, a host forming a communication host may detect a USB connection based on a voltage drop of a high-level (e.g., about 5 V) signal from a DRP signal, and a device forming another communication host may detect a USB connection based on a voltage rise of a low-level (e.g., about 0 V) signal from the DRP signal.

The DRP signal may be output as a toggle signal in which a high-level (e.g., about 5 V) signal and a low-level (e.g., about 0 V) signal alternate according to a duty cycle. On the host side, a USB connection may be detected based on the detection of a voltage drop of a high-level (e.g., 5 V) signal from the DRP signal, and conversely, on the device side, a USB connection may be detected based on the detection of a voltage rise of a low-level (e.g., about 0 V) signal from the DRP signal.

In various embodiments of the disclosure, in a USB connection between a communication host supporting the DRP and a communication host not supporting the DRP, the communication host supporting the DRP may be set to a complementary DFP or UFP role with respect to the counterpart communication host through the duty cycle of the DRP signal. For example, based on the definitive role of the DFP or UFP of the communication host not supporting the DRP, the communication host supporting the DRP may be set to a definitive role of the UFP or DFP complementarily.

In contrast, in a connection between communication hosts supporting the DRP, the role of a non-preferred DFP or UFP may be set depending on the duty cycle of the DRP signal (set probabilistically rather than deterministically depending on the duty cycle between the communication hosts supporting the DRP on both sides), and in this case, a Power Role (PR) swap may be attempted (try. SRC or try. SNK) through Power Delivery (PD) communication via the CC, as described below, a communication host supporting the DRP through try. SRC may be switched from a sink (e.g., a UFP or device) to a source (e.g., a DFP or host), and a communication host supporting the DRP through try. SNK may be switched from a source (e.g., a DFP or host) to a sink (e.g., a UFP or device). Such a PR swap between communication hosts supporting the DRP may be implemented via a DRP state machine, and more specifically, as described below, may be implemented through PD communication via the CC.

For example, in an embodiment of the disclosure, the role swap may refer to a PR swap corresponding to a role swap between the role of a source and the role of a sink in terms of power supply, and may not refer to a data role swap corresponding to a role swap between the role of a source and the role of a sink in terms of data flow.

The current and voltage of the power supply may be set from source current advertising via the CC, and after the DRP signal for the source current advertising, PD communication may be performed via the CC to which BMC coding is applied. Through the PD communication via the CC, an attempt may be made to perform a PR swap for the roles of the DFP and UFP set through the source current advertising described above. In an embodiment of the disclosure, an attempt for the PR swap may be implemented through the PD communication via the CC. For example, a PR swap may be attempted for the role of the DFP (or source) or UFP (or sink) set from the source current advertising described above, a communication host supporting the DRP through try. SRC may be switched from a sink (e.g., a UFP or device) to a source (e.g., a DFP or host), and a communication host supporting the DRP through try. SNK may be switched from a source (e.g., a DFP or host) to a sink (e.g., a UFP or device).

In an embodiment of the disclosure, after a DRP signal in which a high level (e.g., about 5 V) and a low level (e.g., about 0 V) alternate according to a duty cycle, a USB connection may be detected from a voltage drop (e.g., on the host as a communication host) or a voltage rise (e.g., on the device as a communication host) of the DRP signal according to the USB connection of the counterpart communication host, a current of power supply may be set from a pull-up resistor Rp connected to a power terminal on the host as a communication host, and a voltage of the power supply may be set from a pull-down resistor Rd connected to a ground terminal on the device as a communication host. In addition, after the current and voltage of the power supply from the host to the device are set through the source current advertising, the power supply according to the set current and voltage may be performed through the bus VBUS, and the power supply through the bus VBUS may be interrupted by a PR swap, which may be performed according to the try. SRC and/or try. SNK attempts of a communication host supporting the DRP. For example, the power supply through the bus VBUS may be interrupted as a PR swap is performed according to the try. SRC and/or try. SNK attempts of a communication host based on PD communication through the CC.

For example, in an embodiment of the disclosure, PD communication performed on the CC may transmit data to which Biphase Mark Coding (BMC) is applied according to a communication protocol. In BMC, a low signal (e.g., bit 0) may be coded as a signal without a data transition, and a high signal (e.g., bit 1) may be coded as a signal with a data transition. The BMC coding is a type of Manchester coding and may correspond to DC Balance coding. In addition, the PD communication performed on the CC may transmit a peak-peak (Vpp) swing signal of about 1.2 V (or about 1.1 V). For example, the PD communication may detect the connection of the counterpart communication host according to a voltage drop of a high level (e.g., about 5 V) of a DRP signal on the CC or a voltage rise of a low level (e.g., about 0 V), and thereafter, the PD communication performed on the CC may transmit a preamble signal for synchronization in the form of a peak-peak (Vpp) swing signal of about 1.2 V (or about 1.1 V), a PD message (PD contract negotiation) for setting a relatively high power supply such as 20 A@5 V, a PD message for PR swap, or a VDM message for negotiation of USB ALT mode for allocating at least some of super speed channels SSTX1, SSRX1, SSTX2, and SSRX2 to a display interface. For example, a preamble signal that may be transmitted on the CC may be transmitted as a signal that toggles between a low level and a high level at a cycle of about 300 kHz to implement synchronization through the preamble signal without accompanying a clock signal.

Hereinafter, an optical link for supporting a USB connection according to an embodiment of the disclosure, the optical link being connected to a CC between communication hosts on both sides, in which the source current advertising and PD communication describe above are performed, and mediating the source current advertising and PD communication to set the voltage and current of a power supply voltage between the communication hosts on both sides, will be described.

The optical link for supporting a USB connection according to an embodiment of the disclosure may mediate a USB connection between a host and a device forming the communication hosts on both sides. More specifically, the optical link may mediate source current advertising for power supply through a USB connection and communication (PD communication) such as PD messages or VDM messages through the USB connection. For example, the optical link according to an embodiment of the disclosure may include first and second optical communication modules respectively connected adjacent to communication hosts on both sides, for example, a first optical communication module connected adjacent to the host as a communication host, and a second optical communication module connected adjacent to the device as a communication host. For example, the first optical communication module connected adjacent to the host as a communication host of a USB connection may implement a role as a complementary device to the host, and conversely, the second optical communication module connected adjacent to the device as a communication host of the USB connection may implement a role as a complementary host to the device. The host and the device as communication hosts of the USB connection may detect a connection status of a communication counterpart or a pull-up resistor Rp or pull-down resistor Rd of the communication counterpart through an electrical connection between the host and the device on the CC or through a simulation of an electrical connection between the host and the device as communication hosts implemented from the optical link according to an embodiment of the disclosure. For example, the connection status of the counterpart or a pull-up resistor Rp or pull-down resistor Rd of the counterpart may be detected through an optical link that is interposed between the host and the device as communication hosts of the USB connection and simulates an electrical connection between the host and the device.

For example, in an embodiment of the disclosure, simulating a direct electrical connection between the communication hosts through the CC, from an optical link supporting USB communication, may mean, for example, that a source current advertising for setting the voltage and current of the power supply between the communication hosts may be implemented by detecting a voltage signal, such as a voltage drop or a voltage rise, on the CC, similar to a case where, between the host and the device as communication hosts that do not form a direct electrical connection to each other while an optical connection for optical communication is involved, a pull-up resistor Rp connected to a power terminal on the host side and a pull-down resistor Rd connected to a ground terminal on the device side are directly connected while the host and the device form a direct electrical connection between each other through a first electrical connection between the host and a first optical communication module on the side of the host as a communication host, a second electrical connection between the device and a second optical communication module on the side of the device side as a communication host, and an optical connection between the first and second electrical connections.

For example, in an embodiment of the disclosure, in the first electrical connection between the host as a communication host and the first optical communication module, the first optical communication module may implement the role of a complementary device to the host. For example, the host and the first optical communication module forming a direct electrical connection with each other may implement the roles of the host and the device forming communication hosts on both sides. For example, the host and the first optical communication module may form a first electrical connection in which a pull-up resistor Rp connected to a power terminal on the host side and a pull-down resistor Rd connected to a ground terminal on the first optical communication module side implementing the device or the role of the device are connected to each other through a CC of USB communication and voltage distribution is performed through the pull-up resistor Rp and the pull-down resistor Rd.

Similarly, in an embodiment of the disclosure, in the second electrical connection between the device as a communication host and the second optical communication module, the second optical communication module may implement the role of a complementary host to the device. For example, the device and the second optical communication module forming a direct electrical connection with each other may implement the roles of the device and the host forming communication hosts on both sides. For example, the device and the second optical communication module may form a second electrical connection in which a pull-up resistor Rp connected to a power terminal on the second optical communication module side implementing the host or the role of the host and a pull-down resistor Rd connected to a ground terminal on the device side are connected to each other through a CC of USB communication and voltage distribution is performed through the pull-up resistor Rp and the pull-down resistor Rd. In this way, in an embodiment of the disclosure, a direct electrical connection between a host and a device forming communication hosts (e.g., a direct electrical connection without optical communication or optical connection between the communication hosts on both sides, unlike the optical link of the disclosure) may include an electrical connection through a pair of resistors including a pull-up resistor Rp connected to a power terminal on the host side and a pull-down resistor Rd connected to a ground terminal on the device side. However, in an embodiment of the disclosure in which optical communication or optical connection is involved between the communication hosts on both sides to mediate a USB connection on both sides through an optical link, a first electrical connection through a pair of resistors including a pull-up resistor Rp and a pull-down resistor Rd between the host and the first optical communication module, and a second electrical connection through another pair of resistors including a pull-up resistor Rp and a pull-down resistor Rd between the device and the second optical communication module may be formed. In this way, in an embodiment of the disclosure, to simulate an electrical connection through a pull-up resistor Rp and a pull-down resistor Rd on a CC between the host and the device as communication hosts forming a USB connection, a first electrical connection may be formed between the host and the first optical communication module and a second electrical connection may be formed between the device and the second optical communication module. In addition, to allow the first and second electrical connections to simulate a direct electrical connection between the communication hosts on both sides, a first optical communication module, which implements the role of the device while forming the first electrical connection with the host, may implement a connection between a pull-down resistor Rd equivalent to that on the device side and a ground terminal, and a second optical communication module, which implements the role of the host while forming the second electrical connection with the device, may implement a connection between a pull-up resistor Rp equivalent to that on the host side and a power terminal. For example, in an embodiment of the disclosure, the first optical communication module may obtain information about a pull-down resistor Rd of a device as a counterpart at the other end of the second electrical connection, detected from the second optical communication module forming the second electrical connection at the other end of the optical link, and may implement a connection between the pull-down resistor Rd of the device that matches the obtained information and the ground terminal. Similarly, the second optical communication module may obtain information about a pull-up resistor Rp of a host as a counterpart at the other end of the first electrical connection, detected from the first optical communication module forming the first electrical connection at the other end of the optical link, and may implement a connection between the pull-up resistor Rp of the host that matches the obtained information and the power terminal.

In various embodiments of the disclosure, in the connection between the ground terminal and the pull-down resistor Rd, which is formed on the first optical link side, the pull-down resistor Rd may be fixed to about 5.1 kΩ. For example, in an embodiment of the disclosure, the pull-down resistor Rd connected to the ground terminal in the first optical communication module forming the first electrical connection with the host forming a communication host may be fixed to about 5.1 kΩ. In the source current advertising for setting the voltage and current of the power supply between the host and the device forming the communication hosts in the USB connection supported by the optical link according to an embodiment of the disclosure, the voltage of the power supply may be set from a pull-down resistor Rd connected to the ground terminal on the device side, and the current of the power supply may be set from a pull-up resistor Rp connected to the power terminal on the host side. For example, in an embodiment of the disclosure, the optical link for relaying the power supply together with the communication of signals or messages, such as a DRP signal, a PD message, and a Vender Defined Massage (VDM), between the host and the device may mediate a power supply of about 5 V. For example, the power supply of a relatively high voltage such as about 15 V or about 20 V may be achieved through negotiation of a separate PD communication or power delivery. In addition, the source current advertising may be performed before such PD communication, for example, simultaneously with detecting the connection of a counterpart at the other end of USB communication. For example, in the source current advertising for setting the voltage and current of the power supply according to the level of an output voltage on the CC according to the voltage drop or voltage rise while detecting the voltage drop or voltage rise of the DRP signal on the CC, the voltage of the power supply may be set to a fixed voltage of about 5 V, and accordingly, the pull-down resistor Rd, which may be activated while connected to the CC as a pull-down resistor Rd on the device side for setting the voltage (e.g., about 5 V) of the fixed power supply and on the first optical communication module side for implementing the role of the device, may be fixed to a constant value of about 5.1 kΩ.

For example, in an embodiment of the disclosure, on the second optical communication module side that implements the host forming a communication host of a USB connection or the role of the host, the pull-up resistor Rp may be selectively selected from among pull-up resistors Rp having different resistance levels, such as about 10 kΩ, about 22 kΩ, and about 56 kΩ, the selected pull-up resistor Rp may be activated when the pull-up resistor Rp is connected to the CC, and different currents of power supply may be set from the pull-up resistors Rp having different resistance levels that are activated by being connected to the CC. In other words, the host forming the communication host of the USB connection and the first optical communication module forming the first electrical connection may implement the role of a complementary device to the host, and accordingly, the first optical communication module may implement the connection between the CC and the pull-down resistor Rd having fixed 5.1 kΩ, and unlike the first optical communication module which implements the connection between the fixed pull-down resistor Rd and the CC, the second optical communication module forming the second electrical connection with the device forming a communication host of the USB connection may implement the connection between the CC and pull-up resistors Rp having different resistance levels. To this end, the second optical communication module may implement the connection between the CC and a pull-up resistor Rp equivalent to the pull-up resistor Rp connected to the power terminal on the host side as the communication host, and to this end, the CC and a pull-up resistor Rp, which matches information about the pull-up resistor Rp of the host, obtained from the first optical communication module forming the first electrical connection with the host at the other end of the optical link, may be connected to each other, and thus, the pull-up resistor Rp matching the host's pull-up resistor Rp may be activated.

For example, in an embodiment of the disclosure, the process of source current advertising implemented from a first optical communication module forming a first electrical connection with a host and a second optical communication module forming a second electrical connection with a device at both ends of an optical link to simulate a direct electrical connection between the host and the device forming communication hosts of a USB connection may be explained as follows. For example, in an embodiment of the disclosure, the source current advertising may set the voltage and current of the power supply, which makes the host a source of power supply and makes the device a sink of power supply, from a pull-up resistor Rp connected to a power terminal on the host side and a pull-down resistor Rd connected to a ground terminal on the device side, respectively. For example, by detecting a voltage drop (host side) from a relatively high level signal corresponding to a source or a voltage rise (device side) from a relatively low level signal corresponding to a sink from a toggle signal alternating between the source and the sink according to a duty cycle, the connection of a counterpart at the other end of the USB communication may be detected. In addition, a process for setting the voltage and current of the power supply may be performed based on the level of the output voltage detected on the CC from the voltage drop and the voltage rise or from the voltage distribution between the pull-up resistor Rp on the host side and the pull-down resistor Rd on the device side, which are connected to each other through the CC. For example, source current advertising for setting the power supply may be performed following a process for detecting the connection of the counterpart corresponding to the initiation of a USB connection.

In an embodiment of the disclosure, source current advertising may be implemented as follows. First, a connection between the pull-down resistor Rd and the CC may be implemented in a first optical communication module that forms a first electrical connection with a host as a communication host of the USB connection. For example, a connection between the pull-down resistor (Rd), that is, a fixed pull-down resistor Rd (about 5.1 kΩ), and the CC may be implemented in the first optical communication module.

For example, in an embodiment of the disclosure, a first optical communication module forming a first electrical connection with a host and a second optical communication module forming a second electrical connection with a device may be formed with substantially the same configuration. For example, an attempt (try. SRC or try. SNK) of a PR swap may be made from a PD communication performed between a host and a device, which form communication hosts of a USB connection, and from such an attempt of a PR swap, the first optical communication module forming the first electrical connection with the host may need to implement a PR swap forming a second electrical connection with the PR swapped device from substantially the same configuration, and the second optical communication module forming the second electrical connection with the device may need to implement a PR swap forming a first electrical connection with the PR swapped host from substantially the same configuration.

In this way, in an embodiment of the disclosure, in order to support the PR swap of PD communication performed via the CC between communication hosts of a USB connection, each of the first and second optical communication modules may be formed with substantially the same configuration to support the role of a device forming a first electrical connection with the host and the role of a host forming a second electrical connection with the device. For example, each of the first and second optical communication modules may include a plurality of pull-up resistors Rp having different resistance levels, connected in parallel between a power terminal and a CC, a plurality of pull-up side switch elements SW capable of controlling the connection between the pull-up resistors Rp and the CC, a pull-down resistor Rd having a fixed resistance level, connected between a ground terminal and the CC, and a single pull-down side switch element SW capable of controlling the connection between the pull-down resistor Rd and the CC.

In an embodiment of the disclosure, the pull-up side switch element SW and the pull-down side switch element SW may be supplied with switching control signals (a), (b), (c), and (d)) from the first operation processing logic. For example, in the first optical communication module forming the first electrical connection with the host, the pull-down side switch element SW may be turned on by outputting appropriate switching control signals (a), (b), (c), and (d) upon detecting a counterpart at the other end of the USB connection from before the USB connection or from a DRP signal, the pull-up side switch element SW may be turned off, the pull-down resistor Rd may be connected to the CC through the turned-on pull-down switch element SW, and the pull-up resistor Rp may be disconnected from the CC depending on the turn-off of each pull-up side switch element SW. In this way, as the pull-down resistor Rd and the CC are selectively connected to each other based on the switching control signals (a), (b), (c), and (d) generated from the first operation processing logic and output to each switch element SW, only the pull-down resistor Rd may be activated on the first optical communication module side, and an output voltage may be generated according to the voltage distribution with the pull-up resistor Rp connected to the power terminal on the host side.

In this way, in the first optical communication module forming the first electrical connection with the host, the pull-down resistor Rd may be activated by connecting a fixed pull-down resistor Rd equivalent to the fixed pull-down resistor Rd of the device to the CC without detection (information) about the pull-down resistor Rd of the device from the second optical communication module forming the second electrical connection with the device on the other side, which is a counterpart at the other end of the USB connection. However, in contrast, in the second optical communication module forming the second electrical connection with the device, the pull-up resistor Rp equivalent to (for example, corresponding to or matching) the detected pull-up resistor Rp of the host may be connected through detection about the pull-up resistor Rp of the host from the first optical communication module forming the first electrical connection with the host, which is a counterpart at the other end of the USB connection. That is, in the second optical communication module forming the second electrical connection with the device, the pull-up resistor Rp equivalent to (or corresponding to or matching) the detected pull-up resistor Rp of the host through the first electrical connection with the host may be activated. In this way, in the first optical communication module that forms a first electrical connection with a host, a fixed pull-down resistor Rd may be connected to the CC to activate the pull-down resistor Rd, without detecting the pull-down resistor Rd of the device from the second optical communication module that forms the second electrical connection with the device that is a counterpart at the other end of the USB connection. In this case, depending on the voltage generated on the CC from the voltage distribution between the pull-up resistor Rp of the host forming the first electrical connection and the pull-down resistor Rd activated in the first optical communication module, the pull-up resistor Rp of the host may be detected from an output voltage on the CC due to the voltage drop of a DRP signal on the CC or the voltage rise of the DRP signal. For example, the connection of the counterpart communication host may be detected from a voltage drop or voltage rise of a DRP signal transmitted through the CC depending on the connection between the pull-up resistor Rp on the host side and the pull-down resistor Rd on the device side through the CC, and the level of the output voltage of the CC may be detected depending on the output signal of an analog to digital converter (ADC) for categorization or quantization of the output voltage of the CC. For example, in a first optical communication module connected to a host via a first electrical connection, an output voltage of a CC distributed between a pull-up resistor Rp of the host and a pull-down resistor Rd activated in the first optical communication module may be detected. For example, a level of a categorized or quantized output voltage of the CC may be detected from the ADC for categorization or quantization of the output voltage of the CC, and information about the level of the categorized or quantized output voltage of the CC or the categorized or quantized level of the host's pull-up resistor Rp, which may be derived from the level of the categorized or quantized output voltage of the CC may be transmitted from the first optical communication module, which has detected the level of the output voltage on the CC or the resistance level of the host's pull-up resistor Rp, toward the second optical communication module, and may be generated from the first optical communication module as a level confirmation signal and transmitted toward the second optical communication module.

In an embodiment of the disclosure, the second optical communication module may activate a pull-up resistor Rp equivalent to or matching the pull-up resistor Rp of the host, detected from the first optical communication module forming a first electrical connection with the host, for example, corresponding to the categorized or quantized output voltage of the CC or the categorized or quantized level of the host's pull-up resistor Rp, from a level confirmation signal transmitted from the first optical communication module. For example, by applying switching control signals (a), (b), (c), and (d) to a plurality of pull-up switching elements connected between the pull-up resistor Rp and the CC and a pull-down switching element connected between the pull-down resistor Rd and the CC, a pull-up resistor Rp having a resistance level equivalent to or matching that of the pull-up resistor Rp of the host may be activated based on the level confirmation signal received from the first optical communication module. For example, by outputting appropriate switching control signal (a), (b), (c), and (d) toward a switch element SW based on the level confirmation signal received from the first optical communication module, a pull-up resistor Rp having a resistance level equivalent to or matching that of the pull-up resistor Rp of the host may be connected to the CC and activated, while the remaining pull-up resistors Rp and the pull-down resistor Rd may be separated from the CC and deactivated, and the pull-down resistor Rd of the device and the activated pull-up resistor Rp of the second optical communication module may be connected to each other through the CC, thereby generating an output voltage distributed by the pull-down resistor Rd and the activated pull-up resistor Rp on the CC, and the voltage and current of the power supply between the host and the device forming communication hosts on both sides may be set according to the level of the output voltage of the CC. For example, in an embodiment of the disclosure, the host and the device forming the communication hosts on both sides may set the voltage and current of the power supply set between the communication hosts on both sides from a voltage of the CC forming the first electrical connection and a voltage of the CC forming the second electrical connection. For example, the voltage and current of the power supply set between the host and the device forming the communication hosts on both sides may be recognized from the output voltage of the CC generated when the pull-up resistor Rp of the host and the pull-down resistor Rd activated in the first optical communication module are connected to each other or the pull-down resistor Rd of the device and the pull-up resistor Rp activated in the second optical communication module are connected to each other, and power supply of set voltage and current may be ready and a message (PD ready) regarding the completion of power supply readiness from the communication counterpart may be waited for.

In an embodiment of the disclosure, the output voltage distributed through the pull-up resistor Rp of the host and the pull-down resistor Rd activated in the first optical communication module from the first electrical connection between the host and the first optical communication module may be categorized or quantized to recognize the level of the output voltage or the resistance level of the pull-up resistor Rp of the host. For example, the host and the first optical communication module may recognize the voltage and current of the power supply between the host and the device forming the communication hosts on both sides from the level of the output voltage of the CC or the categorized or quantized output level of the CC. In addition, for example, the host may prepare the power supply of the voltage and current set as the power supply from the host as a source toward the device as a sink through the first electrical connection formed between the host and the first optical communication module, and the first optical communication module as a counterpart at the other end of the first electrical connection may recognize the resistance level of the pull-up resistor Rp of the host through the first electrical connection formed between the first optical communication module and the host, generate a level confirmation signal regarding the resistance level of the pull-up resistor Rp, and transmit the level confirmation signal toward the second optical communication module.

Similarly, in an embodiment of the disclosure, the output voltage distributed through the pull-down resistor Rd of the device and the pull-up resistor Rp activated in the second communication module from the second electrical connection between the device and the second optical communication module may be categorized or quantized to recognize the level of the output voltage or the resistance level of the pull-down resistor Rd of the device from the level of the output voltage. For example, the device and the second optical communication module may recognize the voltage and current of the power supply between the host and the device forming the communication hosts on both sides from the level of the output voltage of the CC or the categorized or quantized output level of the CC. In addition, for example, the device may prepare the power supply of the voltage and current set as the power supply from the host as a source toward the device as a sink through the second electrical connection formed between the device and the second optical communication module, and the second optical communication module as a counterpart at the other end of the second electrical connection may recognize the resistance level of the pull-down resistor Rd of the device through the second electrical connection formed between the second optical communication module and the device, generate a level confirmation signal regarding the resistance level of the pull-down resistor Rd, and transmit the level confirmation signal toward the first optical communication module. However, in an embodiment of the disclosure, in the first optical communication module that needs to activate a pull-down resistor Rd equivalent to or matching the pull-down resistor Rd of the device, a fixed pull-down resistor Rd may be activated without requesting a level confirmation signal regarding the resistance level of the pull-down resistor Rd of the device from the second optical communication module. For example, even when the first optical communication module does not confirm the resistance level of the pull-down resistor Rd of the device, the first optical communication module that implements the role of the device may activate a pull-down resistor Rd equivalent to or matching the pull-down resistor Rd of the device from among pull-down resistors Rd having different resistance levels.

In an embodiment of the disclosure, a first optical communication module that implements the roles of a host and a device forming communication hosts of a USB connection may recognize the connection of the counterpart through a first electrical connection, and may recognize the level of an output voltage distributed between a pull-up resistor Rp of the host and an activated pull-down resistor Rd (e.g., a pull-down resistor Rd having a fixed resistance level of about 5.1 kΩ) of the first optical communication module to set the voltage and current of the power supply according to the level of the output voltage and may recognizes the resistance level of the pull-up resistor Rp of the host from the level of the output voltage to transmit a level confirmation signal from the first optical communication module to the second optical communication module. The second optical communication module may activate a pull-up resistor Rp having a resistance level corresponding to that of the pull-up resistor Rp of the host according to the level confirmation signal transmitted from the first optical communication module, for example, may activate a pull-up resistor Rp having a resistance level equivalent to or matching that of the pull-up resistor Rp of the host. In an embodiment of the disclosure, the first optical communication module may activate a fixed resistance level pull-down resistor Rd (e.g., a pull-down resistor Rd having a fixed resistance level of about 5.1 kΩ), and may activate the pull-down resistor Rd having the fixed resistance level before connecting with a host that is a counterpart at the other end of the first electrical connection, or after detecting a connection with the host. For example, in an embodiment of the disclosure, the first optical communication module may deactivate its own activated pull-down resistor Rd (e.g., a pull-down resistor Rd having a fixed resistance level of about 5.1 kΩ) and not implement switching of the pull-down resistor Rd to activate a pull-up resistor Rp having another resistance level or a pull-down resistor Rd having another resistance level, in response to a level confirmation signal from a second optical communication module that forms a second electrical connection with a device that is a counterpart at the other end of the USB connection. However, as described below, unlike the first optical communication module, the second optical communication module may receive a level confirmation signal regarding the pull-up resistor Rp of the host, transmitted from the first optical communication module and implement switching from a first pull-up resistor Rp (e.g., a first pull-up resistor Rp of about 56 kΩ arbitrarily activated at the beginning of a USB connection) arbitrarily activated at the beginning of the connection to a pull-up resistor Rp having a resistance level corresponding to that of the pull-up resistor Rp of the host recognized from the level confirmation signal, for example, a second pull-up resistor Rp having a resistance level equal to or matching that of the pull-up resistor Rp of the host, and may also implement switching from an activated pull-up resistor Rp, i.e., a first pull-up resistor Rp at the beginning of a USB connection, to a second pull-up resistor Rp having a resistance level corresponding to that of the pull-up resistor Rp of the host recognized from the level confirmation signal. For example, in the switching of the pull-up resistor Rp, by deactivating the host's pull-up resistor Rp (e.g., the first pull-up resistor Rp of about 56 kΩ arbitrarily activated at the beginning of the USB connection) arbitrarily activated at the beginning of the connection and activating the second pull-up resistor Rp (e.g., a first pull-up resistor Rp of about 56 kΩ arbitrarily activated at the beginning of the USB connection and a second pull-up resistor Rp of about 10 kΩ or about 22 kΩ) having a resistance level equal to or matching that of the pull-up resistor Rp recognized from the level confirmation signal transmitted from the first optical communication module, switching of the pull-up resistor Rp may be implemented to match the pull-up resistor Rp of the host and the pull-up resistor Rp (the second pull-up resistor Rp) activated in the second optical communication module with each other so that the current and voltage of the power supply set between the host and the first optical communication module, which form the first electrical connection, and the current and voltage of the power supply set between the device and the second optical communication module, which form the second electrical connection, do not mismatch with each other. For example, at the beginning of a USB connection between a host and a device forming communication hosts on both sides, or at the beginning of a connection between a device and a second optical communication module, any pull-up resistor Rp among pull-up resistors Rp having different resistance levels may be activated in the second optical communication module forming a second electrical connection with the device, for example, a pull-up resistor Rp of about 56 kΩ among pull-up resistors Rp having different resistance levels, such as 10 kΩ, 22 kΩ, and 56 kΩ, may be activated while being connected to the CC. In addition, for example, a switching transition of the pull-up resistor Rp may be implemented to activate a second pull-up resistor Rp corresponding to the pull-up resistor Rp of the host recognized from a level confirmation signal transmitted from the first optical communication module.

For example, in an embodiment of the disclosure, at the beginning of a USB connection between a host and a device forming communication hosts on both sides, or at the beginning of a connection between a device and a second optical communication module, the second optical communication module forming a second electrical connection with the device may, for example, activate any first pull-up resistor Rp among pull-up resistors Rp having different resistance levels at the beginning of the connection when the resistance level of the pull-up resistor Rp of the host may be confirmed according to a level confirmation signal from the first optical communication module forming a first electrical connection with the host. For example, the second optical communication module may select and activate the first pull-up resistor Rp so that the lowest current of the power supply between the host and the device is set according to the resistance level of each pull-up resistor Rp, and may select and activate a first pull-up resistor Rp having the highest resistance level so that the current of the power supply of the Default USB Power (e.g., about 500 mA or about 900 mA) is set. For example, in an embodiment of the disclosure, an output voltage distributed between a pull-down resistor Rd of the device and an activated pull-up resistor Rp of the second optical communication module may be generated on a CC forming a second electrical connection between the device and the second optical communication module, and the current and voltage of the power supply may be set according to the level of the output voltage on the CC. In addition, according to the level of the output voltage on the CC forming the first electrical connection, for example, according to detecting the level of the output voltage on the CC on the side of the first optical communication module forming the first electrical connection and according to the level of the output voltage on the CC forming the second electrical connection, for example, according to detecting the level of the output voltage on the CC on the side of the second optical communication module forming the second electrical connection, the voltage and current of the power supply between the host and the device forming the communication hosts may be set. In this case, between the device and the second optical communication module, the activation of the first pull-up resistor Rp having an arbitrary resistance level at the beginning of the connection (e.g., before and after the connection between the device and the second optical communication module) and the switching of the pull-up resistor Rp to a second pull-up resistor Rp corresponding to the resistance level of the pull-up resistor Rp of the host obtained from the first optical communication module after the beginning of the connection may be performed, and thus, an output voltage of the CC forming the second electrical connection and an output voltage of the CC forming the first electrical connection may be made to be equally matched with each other. For example, by making the output voltages generated in the first and second electrical connections equally matched with each other, the current of the power supply may be set between the host and the device as communication hosts, and for example, the setting of the current of the power supply by which the output voltages may correspond to or match each other may be shared between the host forming the first electrical connection and the device forming the second electrical connection.

In an embodiment of the disclosure, at the beginning of connection of the second electrical connection, the first pull-up resistor Rp activated at an arbitrary level in the second optical communication module may be selected and activated as a pull-up resistor Rp having the highest resistance level from among the pull-up resistors Rp having different resistance levels. For example, in an embodiment of the disclosure, according to the output voltage generated on the CC through the second electrical connection, for example, according to the level of the output voltage generated on the CC, a current of a relatively high level of power supply may be set corresponding to a relatively high level of output voltage of the CC. Accordingly, as the first pull-up resistor Rp is activated to the highest level in the second optical communication module forming the second electrical connection with the device, the output voltage distributed according to the first pull-up resistor Rp activated to the highest level may be generated at the lowest level on the CC according to the relatively high voltage drop, and accordingly, the current of the power supply may be set to the lowest level, for example, Default USB Power (e.g., about 500 mA or about 900 mA). In addition, in an embodiment of the disclosure, even when a second pull-up resistor Rp having a resistance level corresponding to the resistance level of the pull-up resistor Rp of the host is activated according to a level confirmation signal from the first optical communication module forming the first electrical connection with the host after the beginning of the connection, and even when the current of the power supply is set according to the output voltage distributed according to the second pull-up resistor Rp, it is impossible to ignore the possibility that the current of the power supply may be set between the device and the second optical communication module according to the first pull-up resistor Rp of the second optical communication module, which is activated at an arbitrary level at the beginning of the connection, on the second electrical connection of the second optical communication module that implements the roles of the device and the host. Therefore, for example, by considering that a level confirmation signal from a first optical communication module forming a first electrical connection with a host may not be normally received due to a transmission delay or transmission error, for example, by setting the current of the power supply between the device and the second optical communication module to the lowest level, damage to electrical components due to relatively high current power supply in the device and the second optical communication module may be prevented, and excessive power supply that exceeds the power supply or power supply capability of the device and the second optical communication module may be prevented.

For example, in an embodiment of the disclosure, after source current advertising for setting the voltage and current of power supply between a host forming a first electrical connection and a first optical communication module implementing the role of a device and between a device forming a second electrical connection and a second optical communication module implementing the role of a host, power supply may be performed via the bus VBUS, and transmission of a BMC coded message may be performed as PD communication performed on a CC. For example, through PD communication performed on the CC, a preamble signal for synchronization in the form of a peak-peak (Vpp) swing signal of about 1.2 V (or about 1.1 V), a PD message (PD contract negotiation) for setting a power supply of relatively high power such as 20 A@5 V, a PD message for PR swap, or a VDM message for negotiation of USB ALT mode for allocating at least some of super speed channels SSTX1, SSRX1, SSTX2, and SSRX2 to a display interface may be transmitted.

In an embodiment of the disclosure, while detecting a voltage drop on the source side of the DRP signal (e.g., a voltage drop of the DRP signal in a second optical communication module that implements the role of the host while forming a second electrical connection with the device) or a voltage rise on the sink side of the DPR signal (e.g., a voltage rise of the DRP signal in a first optical communication module that implements the role of the device while forming a first electrical connection with the host), through the CC, the connection between the host and the device that form communication hosts on both sides in the USB connection, the first electrical connection between the host and the first optical communication module that implements the role of the device, or the second electrical connection between the device and the second optical communication module that implements the role of the host may be captured. In this case, the voltage and current of the power supply between the host and the device that form communication hosts on both sides in the USB connection may be set from the level of the output voltage generated on the CC through the first and second electrical connections, the set power supply may be performed through the bus VBUS, and on the CC, a toggle signal that alternates between a high level and a low level may be output as a DRP signal depending on a voltage drop on the source side (e.g., about 5 V) or a voltage rise on the sink side (e.g., about 0 V). For example, data or a message may be transmitted by converting a high level signal to a low level on the transmission side of one of the host forming the first electrical connection and the first optical communication module implementing the role of the device or on the transmission side of one of the device forming the second electrical connection and the second optical communication module implementing the role of the host. In this way, the PD communication performed on the CC may be implemented in the form of a peak-peak (Vpp) swing signal of about 1.2 V (or about 1.1 V), and encoded data obtained by applying BMC may be transmitted through the PD communication.

In an embodiment of the disclosure, the output voltage on the CC (e.g., the DRP signal on the CC), for example, the output voltage according to the voltage distribution between the pull-up resistor Rp and the pull-down resistor Rd, may be understood as an analog voltage signal, not as a bit stream for data transmission or encoded data obtained by applying BMC to transmission data (for example, the output voltage on the CC formed from the connection of the pull-up resistor Rp and the pull-down resistor Rd through the CC according to the connection of a communication host may be categorized or quantized by an ADC). For example, before the pull-up resistor Rp of the host or the second optical communication module implementing the role of the host and the pull-down resistor Rd of the device or the first optical communication module implementing the role of the device are connected to each other through the CC, that is, before the first electrical connection is formed between the host and the first optical communication module implementing the role of the device and the second electrical connection is formed between the device and the second optical communication module implementing the role of the host, a toggle signal in which a signal on the source side and a signal on the sink side alternate according to a duty cycle as a DRP signal before the voltage drop or voltage rise through the voltage distribution between the pull-up resistor Rp and the pull-down resistor Rd may be understood as an analog voltage signal, not as a bit stream for data transmission or encoded data obtained by applying BMC to transmission data. In addition, an output voltage on the CC for detecting a connection between communication hosts by detecting a change in the output voltage according to the voltage distribution between the pull-up resistor Rp and the pull-down resistor Rd according to the connection between the host and the device as communication hosts, the connection between the host and the first optical communication module, or the connection between the device and the second optical communication module, or an output voltage for setting the voltage and current of the power supply between the communication hosts by detecting the level of the output voltage on the CC may be understood as an analog voltage signal, rather than a bit stream for data transmission or encoded data obtained by applying BMC to transmission data. In an embodiment of the disclosure, the connection between the communication hosts may be captured by capturing a voltage change (voltage drop or voltage rise) of the DRP signal as an output voltage on the CC, and by detecting the level of the output voltage on the CC, the level of the output voltage on the CC may be recognized, for example, through an ADC for categorization or quantization of the output voltage on the CC. In addition, the voltage and current of the power supply between the host and the device that form communication hosts on both sides may be set according to the level of the output voltage on the CC recognized in this way.

In an embodiment of the disclosure, as an output voltage on the CC, a signal of an output voltage formed from a DRP signal as a toggle signal alternating between the source side and the sink side according to a duty cycle, or a signal of an output voltage of a voltage drop or a voltage rise according to a connection between a host and a device that form communication hosts may be processed by a first operation processing logic, and in contrast, in a PD communication performed on the CC, a bit stream for data transmission or encoded data obtained by applying BMC to transmission data, communicated through the CC, may be processed by a second operation processing logic different from the first operation processing logic. For example, in an embodiment of the disclosure, the first and second optical communication modules may include first and second operation processing logics for processing an analog voltage signal transmitted through the CC and encoded data obtained by applying BMC to transmission data, respectively. For example, in an embodiment of the disclosure, the first and second optical communication modules may include an operation processing logic including first and second operation processing logic for processing different signals, respectively. As described below, in an embodiment of the disclosure, the first operation processing logic may be implemented using a central processing unit (CPU) circuit that is advantageous for serial processing, and the second operation processing logic may be implemented using a field programmable gate array (FPGA) circuit that is advantageous for parallel processing. Technical details regarding the first and second operation processing logic will be described in more detail below.

For example, in an embodiment of the disclosure, a host forming a first electrical connection with a first optical communication module, and a device forming a second electrical connection with a second optical communication module may attempt a PR swap through PD communication performed on CC, and attempts (try. SRC, try, and SNK) to each preferred role may be performed. In addition, the first and second optical communication modules may also include substantially the same configuration so as to be able to implement both the role of the host and the role of the device, complementarily to the host and the device, so as to support a PR swap between the host and the device as communication hosts on both sides. For example, in an embodiment of the disclosure, each of the first and second optical communication modules may include first and second operation processing logics, and, for example, may include a plurality of switches SW to which switching control signals (a), (b), (c), and (d) are applied according to a process set in the first operation processing logic and for controlling the connection between a pull-up resistor Rp/pull-down resistor Rd having different resistance levels and the CC, and an ADC for categorizing or quantizing the output voltage on the CC according to a process set in the first operation processing logic. For example, a plurality of pull-up resistors Rp having different resistance levels and a pull-down resistor Rd may be activated while being connected to the CC or deactivated while being separated from the CC, according to the switching control signals (a), (b), (c), and (d) output from the first operation processing logic, and the ADC may be turned on/off under the control of the first operation processing logic (e.g., by the switching control signal (e) applied to the ADC) to categorize or quantize the output voltage on the CC, and the first operation processing logic may recognize the level of the output voltage on the CC from the output of the ADC, and may generate a level confirmation signal regarding the recognized level of the output voltage on the CC and transmit the level confirmation signal toward another optical communication module connected to the other end of the optical link. For example, the first operation processing logic of the first optical communication module forming the first electrical connection with the host may receive, as inputs, a signal of an output voltage distributed between the pull-up resistor Rp of the host and the activated pull-down resistor Rd of the first optical communication module and transmit a level confirmation signal regarding the level of the output voltage of the CC from the output of the ADC for categorization or quantization of the output voltage toward the second optical communication module connected to the other end of the optical link, and the first operation processing logic of the second optical communication module may deactivate the first pull-up resistor Rp having an arbitrary resistance level at the beginning of the connection from the level confirmation signal transmitted from the first optical communication module, and may generate and output the switching control signals (a), (b), (c), and (d) applied to the pull-up resistors Rp/pull-down resistor Rd to perform switching of a pull-up resistor Rp that activates the second pull-up resistor Rp having a resistance level corresponding to that of the pull-up resistor Rp of the host recognized from the level confirmation signal. For example, in an embodiment of the disclosure, the first operation processing logic of the second optical communication module may output a first switching control signal (a), (b), (c), or (d) for activating the first pull-up resistor Rp having the highest resistance level at the beginning of the connection, and may implement switching of the pull-up resistor Rp by outputting a second switching control signal (a), (b), (c), or (d) for activating the second pull-up resistor Rp having a resistance level corresponding to that of the pull-up resistor Rp of the host recognized from the level confirmation signal, according to the level confirmation signal received from the first optical communication module at the other end of the optical link.

In an embodiment of the disclosure, the first operation processing logic or the processor element on which the first operation processing logic is set may include an input terminal to which a DRP signal as an analog voltage signal is input, an input terminal (level confirmation) to which an output from an ADC is input, an input terminal to which a voltage signal of power supply from the bus VBUS is input, and an output terminal for outputting switching control signals (a), (b), (c), and (d) applied to a plurality of switch elements SW for controllably connecting a pull-up resistor Rp and a pull-down resistor Rd having different resistance levels onto a CC, and may include input/output terminals for inputting/outputting transmission data transmitted toward a second optical communication module connected to the other end of the optical link and reception data transmitted from the second optical communication module connected to the other end of the optical link.

In an embodiment of the disclosure, the first and second optical communication modules may include a second operation processing logic for processing a bit stream for data transmission on a CC or encoded data obtained by applying BMC to transmission data. The second operation processing logic may recognize each data from the bit stream for data transmission or the encoded data obtained by applying BMC to the transmission data, and may identify different types of data or messages of PD communication on a CC, such as a preamble signal for synchronizing PD communication on a CC without a separate clock signal, a PD message (PD contract negotiation) for setting a power supply of relatively high power such as 20A@5V, a PD message for a PR swap, or a VDM message for negotiation of a USB ALT mode for allocating at least some of super speed channels SSTX1, SSRX1, SSTX2, and SSRX2 to a display interface, and execute a process set for the different types of data or messages. In this case, the second operation processing logic may cooperate with the first operation processing logic to execute a process set in advance. For example, the second operation processing logic or the processor element in which the second operation processing logic is set may include an input terminal on a BMC data reception line, to which data or messages received via a CC, for example, encoded data obtained by applying BMC, and an output terminal on a BMC data transmission line for outputting data or messages transmitted via the CC, for example, encoded data obtained by applying BMC, and may include an input/output terminal for inputting/outputting data transmitted toward or received from another optical communication module connected to the other end of the optical link.

In an embodiment of the disclosure, a BMC signal processor may be connected to the BMC data reception line, connected to the second operation processing logic, to adjust a data symbol (e.g., a high level of a data symbol) and rising edges and falling edges from a bit stream for data transmission of PD communication, which is input through the BMC data reception line, and prevent data transmission errors. For example, the BMC signal processor may adjust the data symbol and the rising edges and falling edges from the bit stream for data transmission, which is input to the second operation processing logic through the BMC data reception line, and adjust a signal to a form in which the peak of the signal is amplified while the time delays of the rising edges and falling edges are shortened so that the dispersion of the signal is eliminated. An input signal of the BMC signal processor, that is, a BMC signal having time delays of the rising edges and falling edges of about 500 msec, the BMC signal being a peak-peak (Vpp) swing signal of about 1.2 V (or about 1.1 V), may be output as a peak-peak (Vpp) swing signal of about 3.3 V through the BMC signal processor. For example, a BMC signal having time delays of rising edges and falling edges reduced to less than about 100 msec may be output through the BMC signal processor.

For example, in an embodiment of the disclosure, the BMC signal processor may include a comparator (operational (OP) amplifier) having two input terminals, that is, a non-inverting terminal and an inverting terminal. For example, the comparator may have a non-inverting terminal into which a bit stream for data transmission of a BMC signal input through a BMC data reception line is input, and an inverting terminal into which a reference voltage is input, and for example, according to the setting of the reference voltage input to the inverting terminal, a signal of the maximum voltage according to a driving power may be output according to an infinite amplification rate for the voltage difference between the BMC signal on the BMC data reception line, input to the non-inverting terminal, and the reference voltage input to the inverting terminal. For example, while an output signal in the form of a square wave including steep rising edges and falling edges is generated, the delay times of the rising edges and falling edges may be shortened, and depending on the driving power, an input signal of a peak-peak (Vpp) swing of about 1.2 V (or about 1.1 V) may be shaped into an output signal of a peak-peak (Vpp) swing of about 3.3 V. For example, the second operation processing logic may prevent errors in reading a BMC signal, which is input through a BMC data reception line, from a BMC signal shaped so that, through the BMC signal processor, the peak (maximum voltage level) of the BMC signal increases and the dispersion or rising or falling time delay Tr or Tf of the BMC signal is shortened, and the reliability of reading of the second operation processing logic for the BMC signal input through the BMC data reception line from the BMC signal processor may be improved.

In an embodiment of the disclosure, among a pair of lines, that is, a BMC data reception line and a BMC data transmission line, which form a BMC signal line between a host or device as a communication host and the second operation processing logic, the BMC data reception line may be connected to a BMC signal processor and the BMC data transmission line may be connected to a duplexing switch element for selectively opening and closing the BMC data transmission line. For example, in an embodiment of the disclosure, in order to implement two-way communication through a CC formed as a single channel, duplexing may be implemented on a pair of lines, that is, a BMC data reception line and a BMC data transmission line, connected to a CC of a single channel. In an embodiment of the disclosure, among a pair of lines, that is, a BMC data transmission line and a BMC data reception line, which form a BMC signal line, the BMC data reception line that receives BMC data from a host or a device forming a communication host may be given priority in data transmission and thus, the BMC data reception line that receives BMC data from the host or the device may be always open, but a duplexing switch element that may selectively open and close the BMC data transmission line may be connected to the BMC data transmission line that transmits data toward the host or the device through the BMC data reception line. Thus, for example, crosstalk that causes signal interference between the BMC data reception line and the BMC data transmission line may be prevented, and the BMC data transmission line may be selectively open by selectively turning on the duplexing switch element only in a BMC data transmission period for transmitting data toward the host or the device. In this way, the duplexing switch element may be turned off in other periods except for a data transmission period, during which data is transmitted from the first operation processing logic to the host or device, to close the BMC data transmission line, thereby preventing crosstalk due to signal interference between the BMC data transmission line and the BMC data reception line.

For example, in an embodiment of the disclosure, between the host and the first optical communication module, which form the first electrical connection, a DRP signal line through which an analog voltage signal is transmitted, a BMC signal line including a pair of lines, that is, a BMC data transmission line and a BMC data reception line, and ADC input/output lines connected to an ADC may be connected in parallel, and the lines may form a common contact point on the CC and share an analog output voltage signal or a BMC signal transmitted through the CC. In this sense, it may be understood that the DRP signal line, the BMC signal line, and the ADC input/output lines form the CC. Similarly, between the device and the second optical communication module, which form the second electrical connection, a DRP signal line through which an analog voltage signal is transmitted, a BMC signal line including a pair of lines, that is, a BMC data transmission line and a BMC data reception line, and ADC input/output lines connected to an ADC may be connected in parallel, and the lines may form a common contact point on the CC and share an analog output voltage signal or a BMC signal transmitted through the CC. In this sense, it may be understood that the DRP signal line, the BMC signal line, and the ADC input/output lines form the CC.

For example, in an embodiment of the disclosure, the first and second optical communication modules may include first and second operation processing logics for processing a DRP signal transmitted through a DRP signal line and a BMC signal transmitted through a BMC signal line, respectively. For example, in an embodiment of the disclosure, the first operation processing logic may be implemented as a CPU circuit. For example, the first operation processing logic may include an arithmetic and logic unit (ALU) for arithmetic operations and logical operations, as a central processing unit, and a cache or register for temporary storage of variables input to and output from the ALU, and may support serial processing and support multi-processing in a time-sharing manner such as multi-threading. A multi-processor equipped with two or more CPU cores may also support parallel processing.

For example, in an embodiment of the disclosure, the first operation processing logic may detect the connection of a communication counterpart by capturing the voltage drop or voltage rise of the DRP signal from the DRP signal, may set the power supply between the host and the device as communication hosts according to the level of the output voltage on the CC through categorization or quantization of the output voltage on the CC according to the voltage drop or voltage rise of the DRP signal, and may generate a level confirmation signal including information about a pull-up resistor Rp or pull-down resistor Rd recognized according to the level of the output voltage on the CC or the resistance level of a pull-up resistor Rp or pull-down resistor Rd of the communication counterpart that may be calculated from the output voltage, and transmit the level confirmation signal to an optical communication module connected to the other end of the optical link. Conversely, the first operation processing logic may output switching control signals (a), (b), (c), and (d) for a plurality of pull-up resistors Rp having different resistance levels and a pull-down resistor Rd provided in its own optical communication module according to a level confirmation signal received from an optical communication module connected to the other end of the optical link, and may selectively activate the pull-up resistor Rp or the pull-down resistor Rd of the communication host connected to the other end of the optical link by connecting, to CC, a pull-up resistor Rp or a pull-down resistor Rd matching the pull-up resistor Rp or the pull-down resistor Rd of the communication host connected to an optical communication module connected to the other end of the optical link, according to a level confirmation signal transmitted from the optical communication module connected to the other end of the optical link.

In this way, in an embodiment of the disclosure, a series of sequential processing or time-series processing, which includes detecting a connection of a communication counterpart that captures a voltage drop or voltage rise on the CC from the DRP signal, detecting the level of an output voltage according to the connection of a pull-up resistor Rp and a pull-down resistor Rd, generating a level confirmation signal according to the level of the detected output voltage and transmitting the level confirmation signal toward an optical communication module connected to the other end of the optical link, and outputting switching control signals (a), (b), (c), and (d) to a plurality of switch elements SW provided in its own optical link according to the level confirmation signal transmitted from the optical link module connected to the other end of the optical link, may be processed by a first operation processing logic provided by a CPU circuit that is advantageous for serial processing. For example, in an embodiment of the disclosure, source current advertising including the sequential processing or time-series processing as described above may be processed by a first operation processing logic provided by a CPU circuit that is advantageous for serial processing.

Unlike the source current advertising including the sequential processing or time-series processing, the processing of BMC data transmitted via PD communication on the CC after source current advertising may be performed through parallel processing for each of different messages, for example, through independent parallel processing for each of different messages. For example, for independent processing and parallel processing for each message communicated in the form of a request and response through the PD communication, a second operation processing logic provided as an FPGA circuit that is advantageous for parallel processing may be used. For example, in an embodiment of the disclosure, the first and second operation processing logics may be provided from a CPU circuit and an FPGA circuit, respectively, and may be formed from a CPU circuit that is advantageous for serial processing and an FPGA circuit that is advantageous for parallel processing, respectively. For example, in an embodiment of the disclosure, the first and second operation processing logics may be packaged in the form of a single processor element (FPGA element, TX FPGA of the first optical communication module, and RX FPGA of the second optical communication module).

For example, in an embodiment of the disclosure, the second operation processing logic may recognize and process each data from a bit stream for data transmission or encoded data obtained by applying BMC to transmission data, and may identify different types of data or messages of PD communication on a CC, such as a preamble signal for synchronizing PD communication on a CC without a separate clock signal, a PD message (PD contract negotiation) for setting a power supply of relatively high power such as 20A@5V, a PD message for a PR swap, or a VDM message for negotiation of a USB ALT mode for allocating at least some of super speed channels SSTX1, SSRX1, SSTX2, and SSRX2 to a display interface, and execute a process set for the different types of data or messages. In this case, the second operation processing logic may cooperate with the first operation processing logic to execute a process set in advance. For example, in an embodiment of the disclosure, for each message communicated through PD communication on a CC, the second operation processing logic may apply BMC to the encoded data forming each message to form decoded data interpreted from the BMC, and as the decoded data interpreted by applying the BMC in this way, decoded data for BMC data as a result of processing according to a process set on the second operation processing logic may be stored in a memory and may be called from the first operation processing logic. In addition, from processing according to a process designed on the first operation processing logic, for example, from sequential processing for a plurality of different messages or serial processing for different messages, a designation regarding USB pin assignment may be set between two communication hosts on both sides under a USB alternative mode.

In an embodiment of the disclosure, the FPGA circuit forming the second operation processing logic may include a programmable fabric including an array of programmable logic blocks and for performing processing according to a preset process or logic, and may further include an encoder for performing BMC on data transmitted or received via PD communication on a CC and a decoder for performing decoding according to interpretation by the applying of BMC from BMC-coded encoded data.

In an embodiment of the disclosure, the optical communication module may include a multiplexer MUX for implementing multiplexing of a DRP signal and a BMC signal output from different first and second operation processing logics in order to multiplex an output of the first operation processing logic for processing the DRP signal on the CC and an output of the second operation processing logic for processing the BMC signal on one CC and transmit multiplexed outputs through the CC of a single channel, and an optical transmitter connected between the multiplexer MUX and an optical cable. For example, the multiplexer (MUX) may multiplex a level confirmation signal output from the first operation processing logic and a BMC signal output from the second operation processing logic and transmit a multiplexed signal toward an optical communication module as a counterpart at the other end of the optical link through one CC. To this end, a signal obtained by multiplexing the level confirmation signal and the BMC signal through the multiplexer MUX may be converted from an electrical signal to an optical signal, and then the optical signal in which the level confirmation signal and the BMC signal are multiplexed may be transmitted toward an optical communication module as a counterpart at the other end of the optical link through the optical link.

In addition, in an embodiment of the disclosure, the optical communication module may include a demultiplexer DE-MUX for demultiplexing data, transmitted through one CC from an optical communication module connected to the other end of the optical link, toward each of the first and second operation processing logics. For example, the level confirmation signal and the BMC signal, multiplexed into a signal on one CC provided from an optical link or an optical link connected between first and second optical communication modules connected to both ends of the optical link, may be demultiplexed toward each of the first and second operation processing logics. For example, an optical signal in which a level confirmation signal and a BMC signal are multiplexed while being transmitted through an optical link may be converted into an electrical signal in which the level confirmation signal and the BMC signal are multiplexed through an optical-electrical conversion, and the electrical signal in which the level confirmation signal and the BMC signal are multiplexed may be demultiplexed to different first and second operation processing logics through the demultiplexer DE-MUX.

In an embodiment of the disclosure, a PR swap may be attempted (try. SRC or try. SNK) between a host and a device, which form communication hosts of a USB connection, through PD communication on a CC, and a PR swap may be attempted from a role, set according to the connection of the pull-up resistor Rp or pull-down resistor Rd in the communication host or according to the matching of a toggle signal alternating between a source and a sink according to a duty cycle, to a role preferred by the communication host. In this case, the setting of the role may be implemented according to the connection of the pull-up resistor Rp or the pull-down resistor Rd or according to the matching of the toggle signal alternating between a source and a sink according to a duty cycle, according to the PR swap. For example, in a connection between communication hosts supporting a DRP, unlike a deterministic role that does not support a DRP, a role may be set probabilistically, for example, according to the duty cycle of a DRP signal. In this case, in the connection between communication hosts supporting a DRP, an attempt may be made for a PR swap to its preferred role. According to such a PR swap attempt, a first optical communication module forming a first electrical connection with the host as a communication host may implement switching from the role of a complementary device to the host before the PR swap to the role of a complementary host to the device after the PR swap, and conversely, a second optical communication module forming a second electrical connection with the device as a communication host may implement switching from the role of a complementary host to the device before the PR swap to the role of a complementary device to the host after the PR swap.

In an attempt of a PR swap made through PD communication on the CC between a host and a device as communication hosts, the optical communication module may identify a PR swap message in a BMC signal transmitted through PD communication on the CC. Upon receiving the PR swap message, in a first optical communication module that implements the role of a complementary device to the host, the pull-down resistor Rd may be deactivated by disconnecting the pull-down resistor Rd from the CC, and in a second optical communication module that implements the role of a complementary host to the device, the pull-up resistor Rp may be deactivated by disconnecting the pull-up resistor Rp from the CC, and the pull-down resistor Rd may be activated by connecting a pull-down resistor Rd having a fixed resistance level of about 5.1 kΩ onto the CC to implement the role of a complementary device to the PR swapped host. In the second optical communication module, which is switched to implement the role of a complementary device to the host while forming an electrical connection with the host according to the PR swap, the resistance level of the pull-up resistor Rp of the host may be checked according to the level of an output voltage formed on the CC when the pull-up resistor Rp of the host and the pull-down resistor Rd of the second optical communication module implementing the device role are connected to each other. The second optical communication module may transmit a level confirmation signal toward the first optical communication module, connected to the other end of the optical link, according to the resistance level of the pull-up resistor Rp of the host, and in the first optical communication module that implements the role of a complementary device to the host before the PR swap, the pull-down resistor Rd may be deactivated by separating the pull-down resistor Rd from the CC. In addition, by activating a pull-up resistor Rp, which matches or corresponds to the pull-up resistor Rp of the host, according to a level confirmation signal received from the second optical communication module, the first and second optical communication modules may form first and second electrical connections with the host and device, respectively, before the PR swap, and may form first and second electrical connections with the device and host, respectively, after the PR swap. For example, a host and a device forming communication hosts may implement an attempt of a PR swap through PD communication on a CC connecting the host to the device, and may detect a PR swap between the communication hosts by receiving a PR swap message as BMC data transmitted through PD communication, and in various embodiments of the disclosure, as the power supply through the bus VBUS is cut off due to the PR swap between the communication hosts, for example, the PR (Power Role) swap between the communication hosts may be detected by detecting a change in the voltage level of the power supply of the bus VBUS connected to the first and second optical communication modules. For example, the first and second optical communication modules may check the voltage level of the power supply of the bus VBUS from an input terminal connected to the bus VBUS. For example, the first and second optical communication modules may detect a PR swap between the host and the device, which form communication hosts, by detecting a voltage drop in the power supply of the bus VBUS from the input terminal connected to the bus VBUS, for example, by detecting a voltage drop in which the voltage at the input terminal connected to the bus VBUS drops from about 5V level to about 0V level.

An optical link for supporting a USB connection, according to an embodiment of the disclosure may include
an optical communication module (e.g., a first optical communication module) on one side, which forms an electrical connection with a communication host (e.g., a host) on the one side through a configuration channel (CC), between communication hosts (host-device) connected to both sides of the CC, and an optical communication module (e.g., a second optical communication module) on the other side, which forms an electrical connection with a communication host (e.g., a device) on the other side through the CC, between the communication hosts connected to both sides of the CC,
wherein configuration states of the optical communication modules (e.g., the first and second optical communication modules) on the one side and the other side may be set according to configuration states of the communication hosts (e.g., the device and host) on the other side and the one side, respectively, the communication hosts (e.g., the device and host) on the other side and the one side being connected to opposite sides to the communication hosts (e.g., the host and device) on the one side and the other side, respectively, as counterparts forming electrical connections with the optical communication modules on the one side and the other side, respectively. That is, a configuration state of the optical communication module on the one side may be set according to a configuration state of the communication host on the other side, which is connected to an opposite side to the communication host on the one side as a counterpart forming an electrical connection with the optical communication module on the one side, and a configuration state of the optical communication module on the other side may be set according to a configuration state of the communication host on the one side, which is connected to an opposite side to the communication host on the other side as a counterpart forming an electrical connection with the optical communication module on the other side.

The configuration state of the optical communication module (e.g., the first optical communication module) on the one side may be set according to the configuration state of the communication host (e.g., the device) on the other side, which is connected to an opposite side to the communication host (e.g., the host) on the one side as a counterpart forming an electrical connection with the optical communication module (e.g., the first optical communication module) on the one side, and
the configuration state of the optical communication module (e.g., the second optical communication module) on the other side may be set according to the configuration state of the communication host (e.g., the host) on the one side, which is connected to an opposite side to the communication host (e.g., the device) on the other side as a counterpart forming an electrical connection with the optical communication module (e.g., the second optical communication module) on the other side.

For example, the optical link for supporting a USB connection, according to an embodiment of the disclosure may simulate an electrical connection between a first communication host (e.g., the host) and a second communication host (e.g., the device) as communication hosts on both sides. More specifically, to allow the first optical communication module on the one side to simulate a configuration state of the second communication host (e.g., the device) connected to an opposite side to the first communication host (e.g., the host) on the one side, which forms an electrical connection with the first optical communication module on the one side, and allow the second optical communication module on the other side to simulate a configuration state of the first communication host (e.g., the host) connected to an opposite side to the second communication host (e.g., the device) on the other side, which forms an electrical connection with the second optical communication module on the other side, the configuration state of the first optical communication module may be set according to the configuration state of the second communication host (e.g., the device), and the configuration state of the second optical communication module may be set according to the configuration state of the first communication host (e.g., the host).

For example, in an embodiment of the disclosure, the configuration states of the communication hosts (e.g., the host and the device) on the one side and the other side may include a configuration state regarding a role of the host or a role of the device set for each communication host. More specifically, the configuration states of the communication hosts (e.g., the host and the device) on the one side and the other side may include a connection state of a pull-up resistor (e.g., about 56kΩ, about 22kΩ, or about 10kΩ) or a pull-down resistor (e.g., about 5.1kΩ) in each communication host.

For example, the first optical communication module on the one side may simulate a connection state of a pull-up resistor (e.g., about 56kΩ, about 22kΩ, or about 10kΩ) or a pull-down resistor (e.g., about 5.1kΩ) in the second communication host (e.g., the device) connected to an opposite side to the first communication host (e.g., the host) on the one side, which forms an electrical connection with the first optical communication module on the one side, and the second optical communication module on the other side may simulate a connection state of a pull-up resistor (e.g., about 56kΩ, about 22kΩ, or about 10kΩ) or a pull-down resistor (e.g., about 5.1kΩ) in the first communication host (e.g., the host) connected to an opposite side to the second communication host (e.g., the device) on the other side, which forms an electrical connection with the second optical communication module on the other side. More specifically, in an embodiment of the disclosure, the first optical communication module on the one side may simulate a connection state of a pull-down resistor (e.g., about 5.1kΩ) in the second communication host (e.g., the device) connected to an opposite side to the first communication host (e.g., the host) on the one side, which forms an electrical connection with the first optical communication module on the one side, and the second optical communication module on the other side may simulate a connection state of a pull-up resistor (e.g., about 56kΩ, about 22kΩ, or about 10kΩ) in the first communication host (e.g., the host) connected to an opposite side to the second communication host (e.g., the device) on the other side, which forms an electrical connection with the second optical communication module on the other side.

In this way, to allow the first optical communication module on the one side to simulate a configuration state of the second communication host (e.g., the device) connected to an opposite side to the first communication host (e.g., the host) on the one side, which forms an electrical connection with the first optical communication module on the one side, and allow the second optical communication module on the other side to simulate a configuration state of the first communication host (e.g., the host) connected to an opposite side to the second communication host (e.g., the device) on the other side, which forms an electrical connection with the second optical communication module on the other side,
a configuration state of the first optical communication module may be switched according to the configuration state of the second communication host (e.g., the device) recognized by communication (e.g., a level confirmation signal) with the second optical communication module connected to the opposite side to the first optical communication module. For example, in the first optical communication module, the connection state of a pull-up resistor (e.g., about 56 kΩ, about 22 kΩ, or about 10 kΩ) or a pull-down resistor (e.g., about 5.1 kΩ) may be switched, and for example, a resistor activated according to a switching control signal applied to a switch element SW for controlling the connection between each of the pull-up resistor (e.g., about 56 kΩ, about 22 kΩ, or about 10 kΩ) and the pull-down resistor (e.g., about 5.1 kΩ) and the CC may be switched. However, in an embodiment of the disclosure, because the configuration state of the device as the second communication host or the connection state of the pull-up resistor (e.g., about 56 kΩ, about 22 kΩ, or about 10 kΩ) or the pull-down resistor (e.g., about 5.1 kΩ) of the device, which are simulated by the first optical communication module, may be fixed to the pull-down resistor (e.g., about 5.1 kΩ), the configuration state of the first optical communication module or the connection state of the pull-up resistor (e.g., about 56 kΩ, about 22 kΩ, or about 10 kΩ) or the pull-down resistor (e.g., about 5.1 kΩ) of the first optical communication module may not be switched depending on the configuration state (the pull-down resistor is fixed to, for example, about 5.1 kΩ) of the second communication host simulated by the first optical communication module.

For example, a configuration state of the second optical communication module may be switched according to the configuration state of the first communication host (e.g., the host) recognized by communication (e.g., a level confirmation signal) with the first optical communication module connected to the opposite side to the second optical communication module. For example, in the second optical communication module, the connection state of a pull-up resistor (e.g., about 56 kΩ, about 22 kΩ, or about 10 kΩ) or a pull-down resistor (e.g., about 5.1 kΩ) may be switched, and for example, a resistor activated according to a switching control signal applied to a switch element SW for controlling the connection between each of the pull-up resistor (e.g., about 56 kΩ, about 22 kΩ, or about 10 kΩ) and the pull-down resistor (e.g., about 5.1 kΩ) and the CC may be switched. In an embodiment of the disclosure, the configuration state of the host as the first communication host or the connection state of the pull-up resistor (e.g., about 56 kΩ, about 22 kΩ, or about 10 kΩ) or the pull-down resistor (e.g., about 5.1 kΩ) of the host, which are simulated by the second optical communication module, may be set to various resistors (e.g., about 56 kΩ, about 22 kΩ, and about 10 kΩ) depending on the pull-up resistor, and in this case, the configuration state of the second optical communication module or the connection state of the pull-up resistor (e.g., about 56 kΩ, about 22 kΩ, or about 10 kΩ) of the second optical communication module may be switched depending on the configuration state (the pull-up resistor is fixed to, for example, about 56 kΩ, about 22 kΩ, or about 10 kΩ) of the first communication host (e.g., the host) simulated by the second optical communication module.

For example, in an embodiment of the disclosure, the configuration state of at least one of the optical communication modules on the one side and the other side may be switched according to the configuration states of a counterpart communication host at one side of an electrical connection and a communication host connected to an opposite side to the counterpart communication host. More specifically, to allow the first optical communication module on the one side to simulate a configuration state of the second communication host (e.g., the device) connected to an opposite side to the first communication host (e.g., the host) on the one side, which forms an electrical connection with the first optical communication module on the one side, and allow the second optical communication module on the other side to simulate a configuration state of the first communication host (e.g., the host) connected to an opposite side to the second communication host (e.g., the device) on the other side, which forms an electrical connection with the second optical communication module on the other side, the configuration state of the second optical communication module may be switched according to the configuration state of the first communication host (e.g., the host) recognized by communication (e.g., a level confirmation signal) with the first optical communication module.

For example, the first optical communication module may detect the configuration state of the first communication host (e.g., the host), which forms an electrical connection with the first optical communication module, and transmit information about (e.g., a level confirmation signal) the detected configuration status of the first communication host (e.g., the host) to the second optical communication module, thereby switching the configuration state of the second optical communication module.

For example, to allow a first optical communication module on the one side to simulate a connection state of a pull-up resistor or a pull-down resistor in a second communication host (e.g., a device) connected to an opposite side to a first communication host (e.g., a host) on the one side, which forms an electrical connection with the first optical communication module on the one side, and allow a second optical communication module on the other side to simulate a connection state of a pull-up resistor or a pull-down resistor in the first communication host (e.g., the host) connected to an opposite side to the second communication host (e.g., the device) on the other side, which forms an electrical connection with the second optical communication module on the other side, the connection state of the pull-up resistor or the pull-down resistor in at least one of the first optical communication module or the second optical communication module may be switched based on information about the connection state of the pull-up resistor or the pull-down resistor in the second communication host (e.g., the device) or the first communication host (e.g., the host), the information being recognized by communication with the second optical communication module or the first optical communication module connected to an opposite side to the first optical communication module or the second optical communication module.

In an embodiment of the disclosure, an optical link for supporting a USB connection may include a first optical communication module, which forms a first electrical connection with a host as a communication host on one side through a CC, between the host and a device forming communication hosts on both sides of the CC, and a second optical communication module, which forms a second electrical connection with the device as a communication host on the other side through the CC, between the host and the device forming the communication hosts on both sides of the CC,
wherein configuration states of the first and second optical communication modules may be set according to configuration states of a host and device connected to opposite sides to the host and device as counterparts forming the first and second electrical connections, respectively.

For example, the configuration states of the first and second optical communication modules may be set according to configuration states of a communication host as a counterpart and a communication host connected to an opposite side to the communication host as the counterpart, which form the first and second electrical connections, respectively.

For example, the configuration state of the first optical communication module may be set according to a configuration state of a device to simulate a configuration state of a device connected to an opposite side to a host forming the first electrical connection, and
the configuration state of the second optical communication module may be set according to a configuration state of a host to simulate a configuration state of a host connected to an opposite side to a device forming the second electrical connection.

For example, a configuration state of at least one of the first and second optical communication modules may be switched according to a configuration state of a communication host connected to an opposite side to a communication host as a counterpart forming at least one of the first and second electrical connections.

In an embodiment of the disclosure, the configuration state of the second optical communication
module may be switched according to a configuration state of a host connected to an opposite side to a device as a counterpart forming the second electrical connection with the second optical communication module.

For example, the configuration state of the second optical communication module
may be switched according to a configuration state of a host recognized through communication with the first optical communication module forming a first electrical connection with a host connected to an opposite side to a device as a counterpart forming a second electrical connection with the second optical communication module.

For example, the first optical communication module may detect the configuration state of the host through the CC forming the first electrical connection, and may transmit information about the detected configuration state of the host to the second optical communication module, thereby switching the configuration status of the second optical communication module.

According to an optical link according to an embodiment of the disclosure, as communication hosts that do not form a direct electrical connection with each other while an optical connection for optical communication is involved, a host and a device may form a direct electrical connection with each other and simulate a USB connection in which a pull-up resistor Rp connected to a power terminal on the host side and a pull-down resistor Rd connected to a ground terminal on the device side are directly connected through a CC, thereby implementing source current advertising for setting the voltage and current of a driving power between the communication hosts while detecting a voltage signal such as a voltage drop or voltage rise on the CC.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An optical link for supporting a universal serial bus (USB) connection, the optical link comprising:
an optical communication module on one side, which forms an electrical connection with a communication host on the one side through a configuration channel (CC), between communication hosts connected to both sides of the CC; and
an optical communication module on the other side, which forms an electrical connection with a communication host on the other side through the CC, between the communication hosts connected to both sides of the CC,
wherein a configuration state of the optical communication module on the one side is set according to a configuration state of the communication host on the other side, which is connected to an opposite side to the communication host on the one side as a counterpart forming an electrical connection with the optical communication module on the one side, and
a configuration state of the optical communication module on the other side is set according to a configuration state of the communication host on the one side, which is connected to an opposite side to the communication host on the other side as a counterpart forming an electrical connection with the optical communication module on the other side.

2. The optical link of claim 1, wherein the configuration state of the optical communication module on the one side is set according to the configuration state of the communication host on the other side, which is connected to an opposite side to the communication host on the one side as a counterpart forming an electrical connection with the optical communication module on the one side, and
the configuration state of the optical communication module on the other side is set according to the configuration state of the communication host on the one side, which is connected to an opposite side to the communication host on the other side as a counterpart forming an electrical connection with the optical communication module on the other side.

3. The optical link of claim 1, wherein a configuration state of at least one of the optical communication modules on the one side and the other side is switched according to a configuration state of a communication host connected to an opposite side to the communication host as a counterpart forming the electrical connection with the at least one of the optical communication modules.

4. The optical link of claim 3, wherein, in order for a first optical communication module on the one side to simulate a configuration state of a second communication host connected to an opposite side to a first communication host on the one side, which forms an electrical connection with the first optical communication module on the one side, and in order for a second optical communication module on the other side to simulate a configuration state of the first communication host connected to an opposite side to the second communication host on the other side, which forms an electrical connection with the second optical communication module on the other side,
a configuration state of the second optical communication module is switched according to the configuration state of the first communication host recognized through communication with the first optical communication module.

5. The optical link of claim 4, wherein the first optical communication module detects the configuration state of the first communication host, which forms an electrical connection with the first optical communication module, and transmits information about the detected configuration status of the first communication host to the second optical communication module, thereby switching the configuration state of the second optical communication module.

6. The optical link of claim 1, wherein the configuration states of the communication hosts on the one side and the other side include a configuration state regarding a role of a host or a role of a device set for each communication host.

7. The optical link of claim 1, wherein the configuration states of the communication hosts on the one side and the other side include a connection state of a pull-up resistor or a pull-down resistor in each of the communication hosts.

8. The optical link of claim 1, wherein, in order for a first optical communication module on the one side to simulate a connection state of a pull-up resistor or a pull-down resistor in a second communication host connected to an opposite side to a first communication host on the one side, which forms an electrical connection with the first optical communication module on the one side, and in order for a second optical communication module on the other side to simulate a connection state of a pull-up resistor or a pull-down resistor in the first communication host connected to an opposite side to the second communication host on the other side, which forms an electrical connection with the second optical communication module on the other side,
the connection state of the pull-up resistor or the pull-down resistor in at least one of the first optical communication module or the second optical communication module is switched based on information about the connection state of the pull-up resistor or the pull-down resistor in the second communication host or the first communication host, the information being recognized by communication with the second optical communication module or the first optical communication module connected to an opposite side to the first optical communication module or the second optical communication module.

9. An optical link for supporting a universal serial bus (USB) connection, the optical link comprising:
a first optical communication module, which forms a first electrical connection with a host as a communication host on one side through a configuration channel (CC), between the host and a device forming communication hosts on both sides of the CC; and
a second optical communication module, which forms a second electrical connection with a device as a communication host on another side through the CC, between the host and the device forming the communication hosts on both sides of the CC,
wherein configuration states of the first and second optical communication modules are set according to configuration states of a device and host connected to opposite sides to the host and device as counterparts forming the first and second electrical connections, respectively.

10. The optical link of claim 9, wherein the configuration states of the first and second optical communication modules are set according to configuration states of a communication host connected to an opposite side to the communication host as the counterpart, which form the first and second electrical connections, respectively.

11. The optical link of claim 9, wherein the configuration state of the first optical communication module is set according to a configuration state of a device to simulate a configuration state of a device connected to an opposite side to a host as a counterpart forming the first electrical connection, and
the configuration state of the second optical communication module is set according to a configuration state of a host to simulate a configuration state of a host connected to an opposite side to a device as a counterpart forming the second electrical connection.

12. The optical link of claim 9, wherein a configuration state of at least one of the first and second optical communication modules is switched according to a configuration state of a communication host connected to an opposite side to a communication host as a counterpart forming at least one of the first and second electrical connections.

13. The optical link of claim 12, wherein the configuration state of the second optical communication module is switched according to a configuration state of a host connected to an opposite side to a device as a counterpart forming the second electrical connection with the second optical communication module.

14. The optical link of claim 13, wherein the configuration state of the second optical communication module is switched according to a configuration state of a host recognized through communication with the first optical communication module forming a first electrical connection with a host connected to an opposite side to a device as a counterpart forming a second electrical connection with the second optical communication module.

15. The optical link of claim 14, wherein the first optical communication module detects the configuration state of the host through the CC forming the first electrical connection and transmits information about the detected configuration state of the host to the second optical communication module, thereby switching the configuration status of the second optical communication module.

16. An optical link for supporting a universal serial bus (USB) connection, the optical link comprising:
a first optical communication module that provides a pull-down resistor connected to a pull-up resistor of the host to implement a role of a complementary device to the host through the CC forming a first electrical connection with the host between the host and the device that form a communication host on both sides of the CC and generates an output voltage on the CC;
a second optical communication module that provides a pull-up resistor connected to a pull-down resistor of the device to implement a role of a complementary host to the device through the CC forming a second electrical connection with the device and generates an output voltage on the CC; and
an optical cable that provides optical communication between the first optical communication module and the second optical communication module.

17. The optical link of claim 16, wherein each of the first optical communication module and the second optical communication module includes;
a plurality of switch elements that selectively control a connection between each of the pull-up resistor and the pull-down resistor having different resistance levels and the CC; and
a first operation processing logic that outputs a switching control signal for controlling turn-on/turn-off of the plurality of switch elements,
wherein the first operation processing logic of the first optical communication module outputs a switching control signal for connecting a pull-down resistor connected to a pull-up resistor of the host to the CC, and the first operation processing logic of the second optical communication module outputs a switching control signal for connecting a pull-up resistor connected to a pull-down resistor of the device to the CC.

18. The optical link of claim 16, wherein each of the first optical communication module and the second optical communication module includes a plurality of pull-up resistors having different resistance levels and a pull-down resistor having a fixed resistance level.

19. The optical link of claim 16, wherein a first operation processing logic of the first optical communication module outputs a switching control signal for connecting a pull-down resistor having a fixed resistance level to the CC, and
a first operation processing logic of the second optical communication module connects a first pull-up resistor having an arbitrary resistance level among pull-up resistors having a plurality of resistance levels to the CC at an initial stage of connection between the second optical communication module and the device, and then outputs a switching control signal for implementing a switching of the pull-up resistor to switch an activated pull-up resistor, to disconnect the first pull-up resistor from the CC according to a level confirmation signal transmitted from the first optical communication module, and to connect, to the CC, a second pull-up resistor having a resistance level corresponding to a resistance level of a pull-up resistor of the host recognized from the level confirmation signal.

20. The optical link of claim 19, wherein the first operation processing logic of the second optical communication module connects, at the initial stage of connection between the second optical communication module and the device, a pull-up resistor having a highest resistance level among pull-up resistors having different resistance levels, as the pull-up resistor having the arbitrary resistance level, to the CC.

21. The optical link of claim 20, wherein a level of power supply current between the host and the device, as a communication host, is set according to a level of an output voltage on the CC that forms the second electrical connection between the pull-up resistor of the second optical communication module and the pull-down resistor of the device,
wherein the level of the power supply current is set according to a level of an output voltage on the CC that is inversely correlated with a resistance level of the pull-up resistor of the second optical communication module, depending on a voltage drop from the pull-up resistor of the second optical communication module.

22. The optical link of claim 19, wherein the first optical communication module generates a level confirmation signal and transmits the level confirmation signal to the second optical communication module, according to a level of an output voltage generated on the CC that forms the first electrical connection according to voltage distribution between the pull-down resistor of the first optical communication module and the pull-up resistor of the host or according to a resistance level of a pull-up resistor recognized according to the output voltage, and
the second optical communication module connects a pull-up resistor corresponding to the pull-up resistor of the host recognized according to the level confirmation signal to the CC, so that the level of the output voltage on the CC that forms the first electrical connection between the host and the first optical communication module and the level of the output voltage on the CC that forms the second electrical connection between the device and the second optical communication module correspond to each other.

23. The optical link of claim 22, wherein the power supply current between the host and the device is set depending on the output voltage on the CC that forms the first electrical connection between the pull-up resistor of the host and the pull-down resistor of the first optical communication module, or the output voltage on the CC that forms the second electrical connection between the pull-down resistor of the device and the pull-up resistor of the second optical communication module.

24. The optical link of claim 16, wherein each of the host and device forming the communication host supports a Dual Role Port (DRP), which is set to a role of the host or Down Facing Port (DFP) and a role of the device or Up Facing Port (UFP) according to matching of high and low levels that alternate with each other according to a duty cycle set as a DRP signal output on the CC, and
a first operation processing logic of each of the first and second optical communication modules detects a first electrical connection with the host or a second electrical connection with the device from a change in an output voltage on the CC due to a high-level voltage drop of the DRP signal or a low-level voltage rise of the DRP signal, according to a voltage distribution between the pull-up resistor of the host or the second optical communication module implementing the role of the host and the pull-down resistor of the device or the first optical communication module implementing the role of the device,
wherein power supply is set between the host and the device based on the level of the output voltage on the CC according to the high-level voltage drop of the DRP signal or the low-level voltage drop of the DRP signal due to connection between the pull-up resistor and the pull-down resistor.

25. The optical link of claim 24, wherein each of the first and second optical communication modules includes;
a first operation processing logic that processes a DRP signal having alternating high and low levels according to a duty cycle set on the CC or an analog voltage signal having an output voltage that has captured a voltage drop or voltage rise of the DRP signal; and
a second operation processing logic that processes a bit stream for data transmission on the CC or encoded data obtained by applying Biphase Mark Coding (BMC) to transmission data.

26. The optical link of claim 25, wherein, to detect the level of the output voltage of the CC based on a voltage drop or voltage rise of the DRP signal due to connection between the pull-up resistor of the host or the second optical communication module implementing the role of the host and the pull-down resistor of the device or the first optical communication module implementing the role of the device on the CC, the first operation processing logic detects the level of the output voltage of the CC according to an output from an analog to digital converter (ADC) for categorizing or quantizing the output voltage of the CC and sets the power supply between the host and the device.

27. The optical link of claim 25, wherein the first operation processing logic or a processor element in which the first operation processing logic is configured includes an input terminal for the DRP signal to which a signal having an output voltage on the CC that has captured the DRP signal or the voltage drop or rise of the DRP signal is input, an input terminal of an ADC to which an output of an ADC for categorizing or quantizing the output voltage that has captured the voltage drop or rise of the DRP signal is input, and an output terminal for outputting a switching control signal for controlling the connection between a pull-up resistor and pull-down resistor having different resistance levels and the CC.

28. The optical link of claim 27, wherein the first operation processing logic or the processor element in which the first operation processing logic is configured further includes an input/output terminal for outputting transmission data from a first optical communication module or a second optical communication module including the first operation processing logic or the processor element to a second optical communication module or a first optical communication module connected to another end of the optical link and for inputting reception data from the second optical communication module or the first optical communication module connected to the other end of the optical link.

29. The optical link of claim 25, wherein the second operation processing logic or a processor element in which the second operation processing logic is configured includes an input terminal and an output terminal for inputting and outputting, respectively, the bit stream for data transmission or the encoded data obtained by applying BMC to the transmission data.

30. The optical link of claim 29, wherein a BMC signal processor is connected to a BMC data reception line between the input terminal of the second operation processing logic, into which the bit stream for data transmission or the encoded data obtained by applying BMC to the transmission data is input, and the host or the device that functions as the communication host.

31. The optical link of claim 30, wherein the BMC signal processor amplifies a peak of a signal input from the host or device functioning as the communication host toward the second operation processing logic through the BMC data reception line, and shapes the input signal into a signal with a time delay of a rising edge and falling edge thereof that form signal dispersion is shortened.

32. The optical link of claim 31, wherein the BMC signal processor receives an about 1.2 volts or about 1.1 volts peak-to-peak swing signal as an input and outputs an about 3.3 volts peak-to-peak swing signal.

33. The optical link of claim 30, wherein the BMC signal processor includes a comparator including a non-inverting terminal to which a bit stream of a BMC signal input via the BMC data reception line is input and an inverting terminal to which a reference voltage is input.

34. The optical link of claim 29, wherein duplexing is implemented on a BMC data reception line and a BMC data transmission line respectively connected to an input terminal and output terminal of the second operation processing logic, to support bidirectional communication via the CC of a single channel.

35. The optical link of claim 34, wherein a duplexing switch element for opening and closing a transmission line is connected to a BMC data transmission line between the output terminal of the second operation processing logic, from which the bit stream for data transmission or the encoded data obtained by applying BMC to the transmission data is output, and the host or the device that functions as the communication host.

36. The optical link of claim 16, wherein each of the host and device forming the communication host supports a DRP, in which a role of the host or DFP and a role of the device or UFP are set according to matching of high and low levels that alternate with each other according to a duty cycle set as a DRP signal output on the CC,
the host and device attempt a Power Role (PR) swap to reset a previously set role to a role complementary thereto through PD (Power Delivery) communication on the CC, and
as the PR swap is implemented according to the PR swap attempt,
the second optical communication module, which has implemented the role of a complementary host to the device prior to the PR swap, generates a switching control signal to disconnect the pull-up resistor from the CC to disable the pull-up resistor and connect a pull-down resistor having a fixed resistance level to the CC to enable the pull-down resistor having the fixed resistance level, in order to implement the role of a complementary device to a PR-swapped host, and transmits a level confirmation signal regarding the pull-up resistor of the PR-swapped host, which is calculated from or based on an output voltage formed on the CC according to connection between the pull-up resistor of the PR-swapped host and the pull-down resistor of the second optical communication module, toward the first optical communication module connected to another end of the optical link, and
the first optical communication module, which has implemented the role of a complementary device to the host prior to the PR swap, generates a switching control signal to disconnect the pull-down resistor from the CC to disable the pull-down resistor and connect a pull-up resistor corresponding to the pull-up resistor of the PR-swapped host to the CC according to the level confirmation signal received from the second optical communication module to enable the pull-up resistor, in order to implement the role of a complementary host to the PR-swapped device.

37. The optical link of claim 36, wherein the first and second optical communication modules switch a resistor that is enabled and disabled between a pull-up resistor and a pull-down resistor according to the reception of a PR swap message in a BMC signal transmitted via PD communication on the CC between the host and the device that form the communication host.

38. The optical link of claim 36, wherein the first and second optical communication modules switch a resistor that is enabled and disabled between a pull-up resistor and a pull-down resistor, according to a voltage drop in power supply of a VBUS connected to the communication host.

39. The optical link of claim 16, wherein each of the first and second optical communication modules includes a multiplexer that implements multiplexing of a DRP signal and a BMC signal output from different first and second operation processing logics in order to multiplex an output of the first operation processing logic for processing the DRP signal on the CC and an output of the second operation processing logic for processing the BMC signal on the CC and transmit multiplexed outputs through the CC of a single channel, and an optical transmitter connected between the multiplexer and an optical cable.

40. The optical link of claim 39 wherein the multiplexer multiplexes a level confirmation signal output from the first operation processing logic and a BMC signal output from the second operation processing logic, and outputs an electrical signal obtained by multiplexing the level confirmation signal and the BMC signal, and
the optical transmitter performs photoelectric conversion from the electrical signal including the level confirmation signal and the BMC signal multiplexed with each other to an optical signal including the level confirmation signal and the BMC signal multiplexed with each other.

41. The optical link of claim 16, wherein each of the first and second optical communication modules includes a demultiplexer that demultiplexes a signal received from an optical cable providing the CC of a single channel into a DRP signal and a BMC signal respectively input to different first and second operation processing logics, and an optical receiver connected between the demultiplexer and an optical cable so as to demultiplex a signal transmitted from the CC of the single channel into an input of the first operation processing logic for processing the DRP signal on the CC and an input of the second operation processing logic for processing the BMC signal on the CC and transmit the demultiplexed signal to each of the first and second operation processing logics.

42. The optical link of claim 41 wherein each of the first and second optical communication modules includes an optical receiver that converts an optical signal including a level confirmation signal and a BMC signal multiplexed with each other, transmitted from the second and first optical communication modules connected to another end of the optical cable, into an electrical signal including a level confirmation signal and a BMC signal multiplexed with each other, and a demultiplexer that demultiplexes an electrical signal including a level confirmation signal and a BMC signal multiplexed with each other, output from the optical receiver, toward each of the first and second operation processing logics.
